(19) United States
(12) Patent Application Publication
(10) Pub. No.: US 2009/0234074 A1
(43) Pub. Date: Sep. 17, 2009

(54) WATER DISPERSIBLE RESIN, TWO-COMPONENT THERMOSETTING RESIN COMPOSITION, AND METHOD OF PRODUCING THE SAME

(76) Inventors: Daisuke Segawa, Osaka (JP); Teruzo Toi, Osaka (JP); Eiji Ueda, Togane-shi (JP); Shinya Furuta, Osaka (JP); Teruaki Kuwajima, Osaka (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/348,384

(22) Filed: Jan. 5, 2009

(30) Foreign Application Priority Data
Mar. 13, 2008 (JP) 2008-064303

(51) Int. Cl. C08L 75/00; C08F 18/02; C08F 20/04

(52) U.S. Cl. 525/123; 526/320; 526/318.44

(57) ABSTRACT

The water dispersible resin of the present invention is contained in a base component of a two-component thermosetting resin composition. The water dispersible resin is prepared by dispersing a solvent resin in water, which solvent resin is obtained by solution polymerization, carried out in two or more stages, of a monomer mixture containing a polyfunctional monomer, an acid group-containing monomer, and a hydroxyl group-containing monomer, the polyfunctional monomer having a plurality of vinyl groups in its single molecule. The monomer mixture contains the polyfunctional monomer by not less than 0.1% by weight but not more than 3% by weight, and the water dispersible resin thus obtained has an acid value of solid content of not less than 10 mgKOH/g but not more than 45 mgKOH/g, a hydroxyl value of solid content of not less than 50 but not more than 200, and a viscosity of not less than 50 mPa·s but not more than 10,000 mPa·s when a nonvolatile content is 45% by weight. This makes it possible to provide a two-component thermosetting resin composition, which is easily dealt with, formed into a coating film having an excellent appearance, and further, has an excellent pot life.

This Nonprovisional application claims priority under 35 U.S.C. §119(a) on Patent Application No. 064303/2008 filed in Japan on Mar. 13, 2008, the entire contents of which are hereby incorporated by reference.

### FIELD OF THE INVENTION

The present invention relates to a water dispersible resin, a two-component thermosetting resin composition including the water dispersible resin, and a method for producing the water dispersible resin and the two-component thermosetting resin composition. More specifically, the present invention relates to an aqueous two-component thermosetting resin composition.

### BACKGROUND OF THE INVENTION

There are two types of a thermosetting resin composition that is used in a coating field: a one-component thermosetting resin composition that is used without mixing two or more components at the last minute of use; and a multi-component thermosetting resin composition that is used with mixing two or more components at the last minute of use. In such the multi-component thermosetting resin composition, a two-component thermosetting resin composition is most used.

The two-component thermosetting resin composition is made of a base component containing a binder component and a curing agent for curing the binder component. Patent Document 1 discloses a binder dispersion that can be obtained by polymerizing a monomer mixture containing a hydroxyl group-containing monomer. A base component containing the binder dispersion, disclosed in Patent Document 1, is reacted with a curing agent having an isocyanate group so as to form a coating film.

Further, Patent Document 2 discloses, similarly to Patent Document 1, a two-component aqueous coating composition that leverages a curing reaction due to urethane bond of a hydroxyl group-containing resin with an isocyanate group.

However, the binder dispersion disclosed in Patent Document 1 is such that a content ratio of the monomer mixture is large with respect to a solvent. This causes a problem that it is difficult to deal with an obtained resin because a viscosity of the resin thus obtained is high.

Moreover, in the two-component aqueous coating composition disclosed in Patent Document 2, a weight average molecular weight of a contained water dispersible copolymer is 20,000 through 400,000, which is significantly large. This causes a problem that a good appearance cannot be obtained when a coating film is formed.

Here, if molecular weight of the binder dispersion disclosed in Patent Document 1 or the water dispersible copolymer disclosed in Patent Document 2 is reduced, an obtained resin can be easily dealt with, or an appearance of an obtained coating film is improved. However, dispersion stability in the resins thus obtained decreases, thereby resulting in that a pot life may be worsened.

[Patent Document 1]

Japanese Unexamined Patent Publication, Tokukai,

[Patent Document 2]

Japanese Unexamined Patent Publication, Tokukaihei, No. 10-36767

### SUMMARY OF THE INVENTION

An object of the present invention is to provide a two-component thermosetting resin composition that is easily dealt with, formed into a coating film having an excellent appearance, and further, has an excellent pot life.

The inventors of the present invention diligently studied in order to achieve the object. If a molecular weight of a water dispersible copolymer (a water dispersible resin) is reduced for reducing a viscosity so that a resin easily dealt with is obtained, a pot life of an obtained two-component thermosetting resin composition is worsened. The inventors of the present invention considered that this was caused because a cohesion force between molecules in the resin decreased. More particularly, when the cohesion force between molecules in the water dispersible resin decreases, dispersion stability of the water dispersible resin decreases, thereby resulting in that crashes between the water dispersible resin and a curing agent cannot be controlled. The inventers considered that this worsened the pot life.

However, if a molecular weight of the water dispersible resin is large so as to strengthen the cohesion force, fluidity of an obtained coating film is reduced, and an appearance of the coating film deteriorates.

In this regard, the inventors carried out studies in order to obtain a water dispersible resin having a cohesion force in a predetermined range even when the viscosity of the resin is low. As a result, the inventers of the present invention found it possible to realize a two-component thermosetting resin composition that is easily dealt with, formed into a coating film having an excellent appearance, and further, has an excellent pot life, by multi-stage polymerization of a monomer mixture containing a predetermined amount of a polyfunctional monomer. The present invention was accomplished based on the finding.

In order to achieve the above object, a water dispersible resin of the present invention is for being contained in a base component of a two-component thermosetting resin composition. The water dispersible resin is prepared by dispersing a solvent resin in water, which solvent resin is obtained by solution polymerization, carried out in two or more stages, of a monomer mixture containing a polyfunctional monomer, an acid group-containing monomer, and a hydroxyl group-containing monomer, the polyfunctional monomer having a plurality of vinyl groups in its single molecule, the monomer mixture containing the polyfunctional monomer by not less than 0.1% by weight but not more than 3% by weight. The water dispersible resin has an acid value of solid content of not less than 10 mgKOH/g but not more than 45 mgKOH/g; a hydroxyl value of solid content of not less than 50 mgKOH/g but not more than 200 mgKOH/g; and a viscosity of not less than 50 mPa·s but not more than 10,000 mPa·s when a nonvolatile content is 45% by weight.

With the arrangement, the water dispersible resin is considered to have a cohesion force in a predetermined range even if the viscosity is low. This makes it advantageously possible to provide a two-component thermosetting resin composition that is easily dealt with, formed into a coating film having an excellent appearance, and further, has an excellent pot life.

In order to achieve the above object, a two-component thermosetting resin composition of the present invention includes the base component containing the water dispersible resin, and a curing agent containing a polyisocyanate having water dispersibility.

With the arrangement, it is advantageously possible to provide a two-component thermosetting resin composition that is easily dealt with, formed into a coating film having an excellent appearance, and further, has an excellent pot life.

In order to achieve the above object, a method of the present invention for producing a water dispersible resin is to produce a water dispersible resin that is for being contained in a base component of a two-component thermosetting resin composition including, as a curing agent, a polyisocyanate having water dispersibility. The method includes the steps of: carrying out, in two or more stages, solution polymerization of a monomer mixture so as to obtain a solvent resin, the monomer mixture containing a polyfunctional monomer having a plurality of vinyl groups in its single molecule, an acid group-containing monomer, and a hydroxyl group-containing monomer; and dispersing the solvent resin in water. In the method, the monomer mixture has the polyfunctional monomer by not less than 0.1% by weight but not more than 3% by weight, the monomer mixture has an acid value of not less than 10 mgKOH/g but not more than 45 mgKOH/g, and the monomer mixture has a hydroxyl value of not less than 50 mgKOH/g but not more than 200 mgKOH/g.

The method makes it advantageously possible to produce a water dispersible resin that can provide a two-component thermosetting resin composition that is easily dealt with, formed into a coating film having an excellent appearance, and further, has an excellent pot life.

Additional objects, features, and strengths of the present invention will be made clear by the description below. Further, the advantages of the present invention will be evident from the following explanation in reference to the drawings.

### DESCRIPTION OF THE EMBODIMENTS

One embodiment of the present invention is explained below.

In Description, “(meth)acrylic acid” means acrylic acid or methacrylic acid, and similarly, “(meth)acrylate” means acrylate or methacrylate. Further, a “water dispersible resin” means a resin dispersion solution that is prepared by dispersing a resin in water. In addition, “A through B” indicative of a range indicates not less than A but not more than B.

Furthermore, properties described in Description indicate values measured by methods described in aforementioned examples, provided that there is no special explanation. A unit of a “hydroxyl value” that is omitted in Description is “mgKOH/g”.

A. Constitution of two-component thermosetting resin composition

A two-component thermosetting resin composition of the present invention contains a base component containing a water dispersible resin and a curing agent containing a polyisocyanate having water dispersibility.

The water dispersible resin is prepared by dispersing a solvent rein in water. The solvent resin is obtained by carrying out, in two or more stages, solution polymerization of a monomer mixture containing a polyfunctional monomer having a plurality of vinyl groups in its single molecule, an acid group-containing monomer, and a hydroxyl group-containing monomer.

The monomer mixture contains the polyfunctional monomer by 0.1 through 3% by weight.

The water dispersible resin has an acid value of solid content of 10 through 45 mgKOH/g, a hydroxyl value of solid content of 50 through 200, and a viscosity of 50 through 10,000 mPa·s when a nonvolatile content is 45% by weight.

In Description, the “acid value of solid content” and the “hydroxyl value of solid content” of the water dispersible resin indicate values calculated from an acid value and a hydroxyl value of a used monomer mixture.

The following describes more details.

B. Monomer mixture

The monomer mixture contains a polyfunctional monomer, an acid group-containing monomer, and a hydroxyl group-containing monomer.

(Polyfunctional Monomer)

The “polyfunctional monomer” in Description is a monomer having a plurality of vinyl groups in its single molecule. Such the polyfunctional monomer encompasses: polymerizable unsaturated monocarboxylic ester of polyhydric alcohol; polymerizable unsaturated alcoholic ester of polybasic acid; and aromatic compound substituted with two or more vinyl groups.

More specifically, examples of the polyfunctional monomer are aryl(meth)acrylate, ethylene glycol di(meth)acrylate, 1,6-hexanediol di(meth)acrylate, 1,1,1-tris-hydroxymethylethane di(meth)acrylate, tryallyl isocyanurate. From the viewpoint of a polymerization property and commercial availability, ethylene glycol di(meth)acrylate and 1,6-hexanediol di(meth)acrylate are preferable.

The monomer mixture contains the polyfunctional monomer by 0.1 through 3% by weight, preferably 0.1 through 1.0% by weight. When the polyfunctional monomer content is less than 0.1% by weight, a pot life decreases and good smoothness of a formed coating film cannot be obtained. On the other hand, when the polyfunctional monomer content is more than 3% by weight, fluidity decreases and an appearance of an obtained coating film deteriorates.

(Acid Group-Containing Monomer)

The acid group-containing monomer is not especially limited provided that the monomer is an ethylene unsaturated monomer containing an acid group, and encompasses a carboxylic group-containing monomer and a phosphoric group-containing monomer.

Examples of the carboxylic group-containing monomer are (meth)acrylic acid, itaconic acid, maleic acid, fumaric acid, and crotonic acid. Examples of the phosphoric group-containing monomer are vinyl phosphonic acid, allylphosphonic acid, α-phophonostyrene, 2-acrylamid-2-mehylpropanephosphonic acid, and the salts thereof, for example, alkaline metal salts thereof.

The monomer mixture contains the acid group-containing monomer by preferably 1.0 through 15.0% by weight, more preferably 1.5 through 6.0% by weight.

If the content of the acid group-containing monomer is in the range, a resin has more excellent stability, and the resin and a coating material have more excellent storage stability. Further, it is possible to restrain an increase in viscosity of the resin, with the result that it is not necessary to decrease a nonvolatile content of the resin and the coating material. Moreover, in this case, a hydrophilic property of the monomer mixture does not become too high, so that water resistance is more improved in forming a coating film or the like. In addition, since isocyanate contained in the curing agent can be more stably dispersed in water, a pot life is more improved.

(Hydroxyl Group-Containing Monomer)

The hydroxyl group-containing monomer is not especially limited provided that the monomer is an ethylene unsaturated monomer having a hydroxyl group, and encompasses: 2-hydroxyethyl (meth)acrylate, 2-hydroxypropyl (meth)acrylate, 4-hydroxybutyl (meth)acrylate, allyl alcohol, methacrylic alcohol, and adduct of 2-hydroxyethyl(meth)acrylate and ε-caprolactone.

The monomer mixture contains the hydroxyl group-containing monomer by preferably 10.0 through 50.0% by weight, more preferably 10.0 through 35.0% by weight.

If the content of the hydroxyl group-containing monomer is in the range, a resin has more excellent stability and the resin and a coating material have more excellent storage stability. Further, it is possible to restrain an increase in viscosity of the resin, with the result that it is not necessary to decrease a nonvolatile content of the resin and the coating material. Moreover, in this case, a hydrophilic property of the monomer mixture does not become too high, so that water resistance is more improved in forming a coating film or the like. In addition, since isocyanate contained in the curing agent can be more stably dispersed in water, the pot life is more improved.

(Other Monomers)

The monomer mixture may contain a monomer (hereinafter, referred to as a neutral monomer) other than the polyfunctional monomer, the acid group-containing monomer, and the hydroxyl group-containing monomer.

The neutral monomer may be an acrylic monomer or a non-acrylic monomer.

Such the acrylic monomer may be, for example, (meth)acrylic ester such as: methyl(meth)acrylate, ethyl(meth)acrylate, n-propyl (meth)acrylate, isopropyl(meth)acrylate, n-butyl(meth)acrylate, isobutyl(meth)acrylate, t-butyl(meth)acrylate, cyclohexyl(meth)acrylate, 2-ethylhexyl(meth)acrylate, lauryl(meth)acrylate, glycidyl(meth)acrylate, phenyl(meth)acrylate, isbornyl(meth)acrylate, t-butylcyclohexyl(meth)acrylate, dicyclopentadienyl(meth)acrylate, dihydrodicyclopentadienyl(meth)acrylate

On the other hand, such the non-acrylic monomer may be, for example: a polymerizable aromatic compound such as styrene, α-methylstyrene, vinyl ketone, t-butylstyrene, parachlorostyrene and vinyl naphthalene; polymerizable nitrile such as acrylonitrile and methacrylonitrile; vinyl acetate and its derivative. These monomers can be used alone or in combination.

The monomer mixture contains the neutral monomer preferably by 32.0 through 88.9% by weight. More specifically, the polymerizable aromatic compound such as styrene is contained preferably by 3 through 30% by weight. The other monomers may be appropriately contained depending on necessary film performances.

A monomer mixture containing the aforementioned monomers is polymerized and dispersed in water, so as to obtain a water dispersible resin. In this regard, the monomer mixture is designed so that the water dispersible resin thus obtained has an acid value of solid content of 10 through 45 mgKOH/g, and a hydroxyl value of solid content of 50 through 200. It is preferable that the monomer mixture be designed so that the acid value of solid content is 15 through 40 mgKOH/g, and the hydroxyl value of solid content is 100 through 200.

Contained amounts, concentrations of solid content, and the like of various components contained in the base component can be set appropriately.

C. Method for Producing Water Dispersible Resin

A water dispersible resin can be obtained in such a manner that solution polymerization of the aforementioned monomer mixture is carried out in two or more stages, so as to obtain a solvent resin, and the solvent resin thus obtained is dispersed in water.

(Solution Polymerization)

In solution polymerization, the monomer mixture is dropped in n stages (n is an integer of not less than 2). More specifically, an exemplary method of the solution polymerization is such that the monomer mixture is divided into a plurality of fractions, and each fraction of the monomer mixture is dropped, with a polymerization initiator, into a solvent under a heat condition while the solvent is being stirred. A condition of the solution polymerization is, for example, such that a temperature of polymerization is 60 through 160° C., and a drop time is 0.5 through 10 hours.

A fraction of the monomer mixture that is dropped at an n stage is taken as a monomer mixture n. For example, in a case where the solution polymerization is carried out in two stages, the monomer mixture is divided into (i) a fractional monomer mixture (monomer mixture 1) that is dropped at a first step and (ii) a residual monomer mixture (monomer mixture 2) that is a residue of the monomer mixture.

Monomer mixtures 1 through n, which are separately dropped in n stages, are dropped sequentially in this order, and form a resin particle in the solvent. It is considered that the resin particle thus formed exists in the solvent such that a resin formed from the monomer mixture n that is dropped at the n stage is formed into an outer shell, and wraps around a resin formed from the monomer mixtures 1 through n-1 that are dropped at first through n-1 stages.

The solution polymerization is carried out in multiple stages of not less than two stages, but two-stage solution polymerization is preferable in view of reduction in the number of processes. In a case of the two-stage solution polymerization, after a monomer mixture 1 is polymerized in a solvent, a monomer mixture 2 is dropped in the solvent and polymerized.

(Ratio of Monomer Mixtures)

A ratio (weight ratio) between (i) the monomer mixtures (monomer mixtures 1 through n-1) that are formed into a resin to be wrapped and (ii) the monomer mixture (monomer mixture n) that is formed into a resin as an outer shell is preferably 5:5 through 9:1, more preferably 7:3 through 8:2.

In a case where the ratio of the monomer mixtures 1 through n-1 is less than 50%, with respect to an entire amount of the monomer mixtures 1 through n, that is, in a case where an amount of the resin to be wrapped is small, a viscosity of an obtained water dispersible resin is high, and it is difficult to deal with the water dispersible resin. Further, in this case, when the viscosity is adjusted to be a predetermined viscosity, a concentration of solid content decreases. This affects a nonvolatile content of a coating material that is ultimately obtained, which may cause disadvantageous effects on performances of coating operations, for example, decrease in coating efficiency, dripping and the like may occur.

On the other hand, in a case where the ratio of the monomer mixtures 1 through n-1 is more than 90%, with respect to the entire amount of the monomer mixtures 1 through n, that is, in a case where an amount of the resin as the outer shell is small, water dispersion stability of an obtained water dispersible resin may decrease.

The thermosetting resin composition of the present invention is aqueous. In this regard, it is preferable that the monomer mixtures 1 through n be prepared such that the monomer mixture n that is dropped at the n stage has a higher hydrophilic property than the monomer mixtures 1 through n-1 that are respectively dropped at first through n-1 stages.

(Ratio of Polyfunctional Monomer)

A ratio of the polyfunctional monomer used in the monomer mixtures 1 through n-1 is preferably 80 through 100% by weight, more preferably 100% by weight, with respect to an entire amount of the polyfunctional monomer.

In other words, it is preferable that a ratio of the polyfunctional monomer used in the monomer mixture n is not more than 20% by weight, with respect to the entire amount of the polyfunctional monomer.

It is considered that as the ratio of the polyfunctional monomer contained in the monomer mixtures 1 through n-1 is larger, swelling of a water dispersion to be obtained can be restrained. Accordingly, smoothness of a coating film that is ultimately obtained tends to be improved.

(Ratio of Acid Group-Containing Monomer)

A ratio of an acid group-containing monomer used in the monomer mixture n is preferably 90 through 100% by weight, more preferably 100% by weight, with respect to an entire amount of the acid group-containing monomer. It is considered that a resin formed from the monomer mixture n is formed into an outer shell of a resin particle. In this regard, in order that the resin particle is dispersed in water, it is required that the outer shell has a hydrophilic property.

(Ratio of Hydroxyl Group-Containing Monomer)

A ratio of a hydroxyl group-containing monomer used in the monomer mixture n is preferably 20 through 65% by weight, with respect to an entire amount of the hydroxyl group-containing monomer. It is considered that a resin formed from the monomer mixture n is formed into an outer shell of a resin particle. In this regard, in order that the resin particle is dispersed in water, it is required that the outer shell has a hydrophilic property.

(Resin Particle)

A volume average particle diameter of a resin particle obtained is preferably in a range of 0.01 through 1.0 μm.

If the volume average particle diameter is in the range, a coating film to be obtained has an excellent appearance, and a polyisocyanate contained in a curing agent can be more dispersed in water. This improves a pot life more. An average particle diameter can be controlled, for example, by adjusting a monomer composition or a polymerization condition. The volume average particle diameter can be measured, for example, with the use of a laser light scattering method.

The polymerization initiator is not especially limited provided that the polymerization initiator is the one generally used in polymerization. Examples of the polymerization initiator are an azo compound and peroxide. In general, an amount of the polymerization initiator is preferably 0.1 through 18 parts by weight, more preferably 0.3 through 12 parts by weight, with respect to 100 parts by weight of a monomer mixture.

A solvent that can be used in the present invention is not especially limited provided that the solvent does not cause disadvantageous effect on reaction. Examples of the solvent are alcohol, ketone, and hydrocarbon solvent. Moreover, in order to adjust a molecular weight, a chain transfer agent such as mercaptan like lauryl mercaptan, and α-methylstyrene dimer can be used if necessary.

Next, the solvent is removed from the solution containing resin particles, and water is poured thereto so that the resin particles are dispersed in water. As such, a water dispersible resin is obtained. A neutralizing agent may be added at this moment. The neutralizing agent neutralizes the acid group in the resin so that the resin has water solubility or dispersibility. Examples of such the neutralizing agent encompass: ammonia, trimethylamine, triethylamine, dimethylethanolamine, triethanolamine, tetraethylammonium hydroxide, and diethylaminoethanol.

A viscosity of the water dispersible resin thus obtained satisfies the condition of the acid value of solid content and the hydroxyl value of solid content. In addition, when a nonvolatile content is 45% by weight, the viscosity is 50 through 10,000 mPa·s, preferably 300 through 8,000 mPa·s under the condition. The viscosity indicates values measured, for example, by use of an E type viscometer.

Further, a number average molecular weight of the water dispersible resin is preferably 1,000 through 20,000, more preferably 3,000 through 10,000. The number average molecular weight indicates values measured by GPC in terms of polystyrene.

D. Curing Agent

The curing agent has water dispersibility and contains a polyisocyanate.

The polyisocyanate is a compound having two or more isocyanate groups in its single molecule. The polyisocyanate may be, for example, either of aliphatic system, alicyclic system, aromatic system, and aromatic-aliphatic system.

More specifically, examples of the polyisocyanate encompass: 2,4-trilene diisocyanate (2,4-TDI), 2,6-trilene diisocyanate (2,6-TDI), and a mixture thereof (TDI), diphenylmethane-4,4′-diisocyanate (4,4′-MDI), diphenylmethane-2,4′-diisocyanate (2,4′-MDI), and a mixture thereof (MDI), naphthalene-1,5-diisocyanate (NDI), 3,3′-dimethyl-4,4′-biphenylene diisocyanate (TODI), xylylene diisocyanate (XDI), dicyclohexylmethane diisocyanate (hydrated HDI), isophorone diisocyanate (IPDI), hexamethylene diisocyanate (HDI), hydrated xylylene diisocyanate (HXDI).

More specifically, the curing agent may contain an emulsifier for dispersing the polyisocyanate in water, or may be a blocked polyisocyanate in which an isocyanate group of the polyisocyanate is masked with a hydrophilic block agent. The block agent is stable at a room temperature, but when the block agent is heated such that the temperature becomes not less than a dissociation temperature, a free isocyanate group can be regenerated. For example, when a polyethylene oxide unit is introduced into the polyisocyanate, the polyisocyanate is hydrophilized. The polyisocyanate thus hydrophilized can be used as a curing agent.

E. Ratio Between Base Component and Curing Agent

A content of the curing agent is preferably 20 through 100% by weight, with respect to solid content of the resin contained in the base component. If the content of the curing agent is in the range, it is possible to restrain an obtained cured film from being too hard, without decreasing a curing property of the film.

The base component and the curing agent are contained such that an equivalent value between a hydroxyl group in the base component and an isocyanate group in the curing agent is 1:1 through 1:2, more preferably 1:1.2 through 1:1.6. In this range, it is possible to improve a curing property of an obtained thermosetting resin composition.

An amount of the polyisocyanate compound in the curing agent can be appropriately set.

F. Two-component aqueous coating composition The two-component thermosetting resin composition of the present invention is applicable to an aqueous coating composition. The aqueous coating composition contains the base component and the curing agent. Further, the aqueous coating composition can be used in a method for forming a multilayer coating film, which method includes the steps of (1) forming an intermediate coating film by applying a composition for intermediate coating on a surface of an object to be coated, (2) forming a base coating film and a top coating film by applying sequentially, by a wet-on-wet coating technique, a composition for base coating and a composition for top coating to the intermediate coating film that is not fully cured, and (3) curing simultaneously, by heating, the intermediate coating film, the base coating film, and the top coating film, obtained in the steps (1) and (2).

In the aqueous coating composition, a solid content of the water dispersible resin is preferably not less than 30% by weight, more preferably not less than 50% by weight, with respect to the entire solid content of the base component in the aqueous coating composition. When the ratio of the solid content of the water dispersible resin is less than 30% by weight, water resistance of an obtained coating film tends to decrease.

A ratio between the base component and the curing agent is the same as described in “E. Ratio between base component and curing agent”, and therefore is not described here.

In addition to the two-component thermosetting resin composition, the aqueous coating composition can contain appropriate additives for a coating material.

Concrete examples of the additives for a coating material may be, for example, a curing catalyst such as a metal dryer, aqueous ammonia, a pH adjuster such as sodium hydroxide, a defoaming agent, a leveling agent, a UV absorber, an oxidation inhibitor, a fire retardant, an antistatic agent, a compatibilizer, a crosslinking agent, a thickening agent, a static agent, a plasticizer, a heat stabilizer, and a light stabilizer. The number, type, and amount of additives for a coating material can be appropriately selected depending on a purpose. Needless to say, the aqueous coating composition of the present invention can further contain a coloring component such as a colorant and a dye compound, and other resin components.

The aqueous coating composition of the present invention is preferably applicable to: an enamel coating; various coating purposes for construction, automotive body, automobile components, and the like; a covering material such as print ink; a bonding material for nonwoven material; an adhesive agent; a filler; a forming material; a resist and the like. The aqueous coating composition of the present invention can be especially preferably used as a coating material for top coating, a coating material for base coating, and a coating material for intermediate coating (primer surfacer) for automotive body, which coating materials are used in the method for forming multilayer coating film.

The coating material for top coating, the coating material for base coating, and the coating material for intermediate coating have the following features.

The coating material for intermediate coating that forms an intermediate coating film contains the curable resin composition of the present invention, various organic and inorganic coloring pigments, an extender pigment, and the like. The intermediate coating film can cover a background, maintain smoothness of a surface of a top coating (improve an appearance), and provide coating properties (resistance to shock or chipping, and the like).

Examples of the coloring pigments used in the coating material for intermediate coating encompass: (i) an organic pigment such as azochelate pigment, an insoluble azo pigment, a condensed azo pigment, a diketopyrrolopyrrole pigment, a benzimidazolon pigment, a phthalocyanine pigment, an indigo pigment, a perinone pigment, a perylene pigment, a dioxane pigment, a quinacridone pigment, an isoindolinone pigment, and a metal complex pigment; and (ii) an inorganic pigment such as chrome yellow, yellow iron oxide, colcothar, carbon black, and titanium dioxide. In addition, as an extender pigment, an extender pigment such as calcium carbonate, barium sulfate, clay, and talc, or a flat pigment such as an aluminum powder and a mica powder may be also used.

Normally, a gray coating material for intermediate coating in which carbon black and titanium dioxide are contained as main pigments is used. Moreover, a coating material for intermediate coating that contains, in combination, set gray that is conformed with lightness or coloration of a top coating color, and various coloring pigments, i.e., a so-called color coating material for intermediate coating can be used.

A film thickness of a dried intermediate coating film varies depending on an intended purpose, but is 10 through 60 μm in most cases, and preferably 10 through 40 μm. If the thickness exceeds the upper limit, vividness may decrease or a problem such as unevenness or flowing may be caused in coating. Meanwhile, if the thickness is less than the lower limit, a background cannot be covered and the coating film may be formed discontinuously.

The composition for base coating contains the curable resin composition of the present invention, an extender pigment, and at least one of various photoluminescent pigments and coloring pigments.

Such the photoluminescent pigments can be, for example: an aluminum flake pigment, a coloring aluminum flake pigment, a metal oxide covered alumina flake pigment, an interference mica pigment, a coloring mica pigment, a metal oxide covered glass flake, a plated glass flake, a metal oxide covered silica flake pigment, a metal titanium flake, a graphite, a stainless flake, a plate-like iron oxide, a phthalocyanine flake, and a hologram pigment.

Further, as the coloring pigments, basically, the same organic and inorganic coloring pigments as used in the composition for intermediate coating can be used, and the same extender pigments as used in the composition for intermediate coating can be basically used.

An amount of the photoluminescent pigments and coloring pigments to be added can be appropriately set so that intended coloration is developed. In addition to the photoluminescent pigments and coloring pigments, various extender pigments and the like can be also used.

A pigment weight concentration (PWC, which is calculated according to the expression: total weight of pigments/(total weight of pigments+weight of solid content in a coating resin)) of the photoluminescent pigments or the coloring pigments in a coating material is preferably less than 50% by weight, more preferably 30% by weight, with respect to entire pigments. When the PWC is more than 50% by weight, an appearance of the coating film deteriorates.

In a case where the composition for base coating is applied to an automotive body or the like, in view of design, the composition for base coating is applied by air electrostatic spraying, or multiple-stage coating in preferably two stages with the use of a rotary-atomizing type electrostatic coating machine generally called “μμ (micro micro) bell”, “μ (micro) bell”, or “metabell”.

A film thickness of a dried base coating film obtained varies depending on an intended purpose, but is 5 through 20 μm in many cases, and preferably 6 through 18 μm. If the thickness exceeds the upper limit, a problem such as unevenness, dripping, or pinhole may be caused in coating. Meanwhile, if the thickness is less than the lower limit, an obtained coating film is sheer or uneven and an appearance of the coating film is deteriorated.

A top coating film that is formed after the base coating film is formed is provided for smoothing unevenness or flicker that is caused due to photoluminescent pigments contained in the base coating film, and protecting the base coating film. It is preferable to form the top coating film, specifically, by an applying method with the use of the aforementioned rotary-atomizing type electrostatic coating machine such as the μμ bell or the μ bell.

A composition for top coating (coating material for top coating) contains the curable resin composition of the present invention.

A film thickness of a dried top coating film formed from the coating material for top coating varies depending on an intended purpose, but is 10 through 80 μm in many cases, and more preferably around 20 through 60 μm. If the thickness exceeds the upper limit, vividness may decrease or a problem such as unevenness, pinhole or flowing may be caused in coating. Meanwhile, if the thickness is less than the lower limit, a background cannot be covered and the coating film may be formed discontinuously.

After the top coating film is formed, a temperature to cure the base coating film is set preferably in a range of 80 through 180° C., preferably 120 through 160° C., so that cured coating films having a high degree of crosslinking can be obtained. If the temperature is more than the upper limit, the coating film becomes hard and fragile. If the temperature is less than the lower limit, the coating film is not sufficiently cured. A time required for curing varies depending on the temperature, but is appropriately set to 10 through 30 minutes at the temperature of 120° C. through 160° C.

A film thickness of a laminated coating film that is formed in the present invention is 30 through 300 μm in many cases, and preferably 50 through 250 μm. If the thickness is more than the upper limit, film properties such as thermal cycle and the like decrease, and if the thickness is less than the lower limit, strength of the film decreases.

After the coating material for intermediate coating and the coating material for base coating are applied, an obtained laminated coating film may be left to stand at a room temperature as necessary so that the laminated coating film is dried, or heated at a temperature more than the room temperature, for example, 80 through 120° C. so that the laminated coating film is forcibly dried up.

As described above, according to the present invention, it is possible to provide a two-component thermosetting resin composition that is easily dealt with, formed into a coating material having an excellent appearance, and further, has an excellent pot life.

Further, the water dispersible resin of the present invention is prepared by carrying out the solution polymerization, preferably in two stages.

This makes it possible to reduce the number of processes, and increase production efficiency.

In the water dispersible resin of the present invention, the solution polymerization is carried out in two or more stages such that the monomer mixture is divided into monomer mixtures 1 through n so that the monomer mixtures 1 through n are separately added in n stages sequentially in this order and polymerized where n is the number of stages of polymerization. In this regard, it is preferable that a weight ratio between the monomer mixtures 1 through n-1 and the monomer mixture n be not less than 5:5 but not more than 9:1.

In the water dispersible resin of the present invention, it is preferable that a ratio of the polyfunctional monomer used in the monomer mixtures 1 through n-1 be not less than 80% by weight but not more than 100% by weight, with respect to an entire amount of the polyfunctional monomer.

With the arrangement, it is possible to more improve fluidity of a coating material obtained so that a coating film is formed to be smoother.

In the water dispersible resin of the present invention, it is preferable that a ratio of the acid group-containing monomer used in the monomer mixture n be not less than 90% by weight but not more than 100% by weight, with respect to an entire amount of the acid group-containing monomers.

With the arrangement, resin particles can be dispersed better in water, thereby making it possible to provide a two-component thermosetting resin composition which is more easily dealt with, formed into a coating film having a better appearance, and further, has a more excellent pot life.

In the water dispersible resin of the present invention, it is preferable that a ratio of the hydroxyl group-containing monomer used in the monomer mixture n be not less than 20% by weight but not more than 65% by weight, with respect to an entire amount of the hydroxyl group-containing monomer.

With the arrangement, resin particles can be dispersed better in water, thereby making it possible to provide a two-component thermosetting resin composition which is more easily dealt with, formed into a coating film having a better appearance, and further, has a more excellent pot life.

A base component of the present invention for being contained in a two-component thermosetting resin composition includes, as a curing agent, a polyisocyanate having water dispersibility. The base component includes the water dispersible resin.

With the arrangement, it is advantageously possible to provide a two-component thermosetting resin composition that is easily dealt with, formed into a coating film having an excellent appearance, and further, has an excellent pot life.

Further, in the two-component thermosetting composition of the present invention, it is preferable that an equivalent ratio between a hydroxyl group contained in the base component and an isocyanate group in the curing agent be not less than 1 but not more than 2, with respect to a hydroxyl group in the base component.

With the arrangement, it is possible to more improve a curing property of a thermosetting resin composition.

The two-component thermosetting resin composition may be a composition for top coating, or a composition for base coating. Furthermore, the two-component thermosetting resin composition may be a composition for intermediate coating, or a primer surfacer.

The two-component thermosetting resin composition is preferably for use in a method for forming a multilayer coating film, which method includes the steps of: (1) forming an intermediate coating film by applying a composition for intermediate coating on a surface of an object to be coated, (2) forming a base coating film and a top coating film by applying sequentially, by a wet-on-wet coating technique, a composition for base coating and a composition for top coating to the intermediate coating film that is not fully cured, and (3) curing simultaneously, by heating, the intermediate coating film, the base coating film, and the top coating film, obtained in the steps (1) and (2).

A method of the present invention for producing a two-component thermosetting resin composition is to produce a two-component thermosetting resin composition containing a base component and a curing agent including a polyisocyanate having water dispersibility. The method includes the steps of producing a water dispersible resin according to the method for producing a water dispersible resin, and mixing the curing agent with the base component containing the water dispersible resin.

The method makes it advantageously possible to produce a two-component thermosetting resin composition that is easily dealt with, formed into an excellent appearance, and further, has an excellent pot life.

### EXAMPLES

The following describes the present invention in more detail with reference to Examples, but the present invention is not limited to Examples described below. In Examples, “part” and “%” are based on weight provided that there is no special description.

### Production Example 1

### Production of Water Dispersible Resin 1

In a normal reaction vessel for producing acrylic resin emulsion, equipped with a stirrer, a thermometer, a dropping funnel, a reflux condenser, a nitrogen gas inlet pipe, and the like, 675 parts of propylene glycol monomethyl ether (hereinafter, referred to as MP) were charged and stirred. During the stirring, a temperature was increased to 120° C. Then, a monomer mixture 1 having a composition shown in Table 1 was dropped in the reaction vessel over 1.5 hours while being stirred. While the monomer mixture 1 was being dropped, a polymerization initiator solution that was prepared such that 22 parts of Kayaester O (a polymerization initiator, manufactured by Kayaku Akzo Corporation) were dissolved in 145 parts of MP was also evenly dropped in the reaction vessel until the dropping of the monomer mixture 1 was completed.

After the monomer mixture 1 was dropped, the reaction was further continued at 120° C. for 1 hour. During the reaction, a monomer mixture 2 having a composition shown in Table 1 was dropped in the reaction vessel over 1 hour while being stirred. At this time, in the similar manner that the monomer mixture 1 was dropped, while the monomer mixture 2 was being dropped, a polymerization initiator solution that was prepared such that 5 parts of Kayaester O were dissolved in 36 parts of MP was also evenly dropped in the reaction vessel. The dropping of the solution was continued until the dropping of the monomer mixture 2 was completed.

After the monomer mixture 2 was dropped, the reaction was further continued at 120° C for 2 hours. After that, a reactant obtained was cooled down to 90° C., and 81 g of propylene glycol monobutyl ether (hereinafter, referred to as PnB) were added to the reactant. Then, a pressure was reduced so that 856 g of MP were distilled away. After the pressure was increased to a normal pressure, 81 g of Solvesso 100 (product name, manufactured by Exxson Chemical), 12 g of dimethylethanolamine, 37 g of triethanolamine were added to the reactant and mixed evenly. Then, a resultant obtained was dispersed in 888 g of water so as to obtain a water dispersible resin 1.

Designed values of the water dispersible resin 1 were such that an acid value of solid content was 30 mgKOH/g, and a hydroxyl value of solid content was 140. The water dispersible resin 1 thus obtained had a nonvolatile content (NV) of 45% by weight, a viscosity of about 5,000 mPa·s (25° C., 1 rpm), a volume average particle diameter of 190 nm, and a number average molecular weight of 5,000 (Table 2).

The nonvolatile content of the water dispersible resin was measured based on JIS K5600 1-2. The viscosity of the water dispersible resin was measured, by use of an E type viscometer (for example, an R-100 type viscometer, manufactured by Toki Sangyo Co., Ltd), at 1 rpm and 25° C. The number average molecular weight was measured by use of Gel Permeation Chromatography (GPC), in terms of polystyrene. The volume average particle diameter of the water dispersible resin was measured by a laser light scattering method with the use of LB-500 (manufactured by HORIBA).

In the following examples, the properties were also measured by the aforementioned methods provided that there is no special explanation.

TABLE 1

| | CORE (part by weight) | | | | | | | | SHELL (part by weight) | | | |
|---|---|---|---|---|---|---|---|---|---|---|---|---|
| | ST | MMA | nBA | nBMA | IBOMA | HEMA | EGDM | AA | nBMA | EGDM | HEMA | AA |
| Pro. Ex. 1 | 45.00 | 45.00 | 107.00 | 181.00 | 176.00 | 164.00 | 2.00 | | 17.00 | | 128.00 | 35.00 |
| Pro. Ex. 2 | 45.00 | 45.00 | 112.00 | 172.00 | 178.00 | 164.00 | 4.00 | | 17.00 | | 128.00 | 35.00 |
| Pro. Ex. 3 | 45.00 | 45.00 | 95.00 | 185.00 | 182.00 | 164.00 | 4.00 | | 79.00 | | 66.00 | 35.00 |
| Pro. Ex. 4 | 45.00 | 45.00 | 61.00 | 203.00 | 106.00 | 256.00 | 4.00 | | 25.00 | | 120.00 | 35.00 |
| Pro. Ex. 5 | 45.00 | 125.00 | 136.00 | 80.00 | 168.00 | 164.00 | 2.00 | | 56.00 | | 107.00 | 17.00 |
| Pro. Ex. 6 | 45.00 | 63.00 | 158.00 | 63.00 | 218.00 | 166.00 | 7.00 | | 46.00 | 1.00 | 105.00 | 28.00 |
| Com. | 45.00 | 47.00 | 107.00 | 198.00 | 176.00 | 292.00 | | 35.00 | | | | |
| Ex. 1 | | | | | | | | | | | | |
| Com. | 45.00 | 43.00 | 107.00 | 198.00 | 176.00 | 292.00 | 4.00 | 35.00 | | | | |
| Ex. 2 | | | | | | | | | | | | |
| Com. | 45.00 | 43.00 | 107.00 | 198.00 | 176.00 | 292.00 | 4.00 | 35.00 | | | | |
| Ex. 3 | | | | | | | | | | | | |
| Com. | 45.00 | 27.00 | 154.00 | 80.00 | 205.00 | 164.00 | 45.00 | | 17.00 | | 128.00 | 35.00 |
| Ex. 4 | | | | | | | | | | | | |
| Com. | 45.00 | 63.00 | 137.00 | 117.00 | 194.00 | 164.00 | | | 17.00 | | 128.00 | 35.00 |
| Ex. 5 | | | | | | | | | | | | |
| Com. | 45.00 | 45.00 | 112.00 | 172.00 | 178.00 | 164.00 | 4.00 | | 17.00 | | 128.00 | 35.00 |
| Ex. 6 | | | | | | | | | | | | |
| Com. | 45.00 | 45.00 | 99.00 | 48.00 | 97.00 | 382.00 | 4.00 | | 5.00 | | 140.00 | 35.00 |
| Ex. 7 | | | | | | | | | | | | |
| Com. | 45.00 | 90.00 | 117.00 | 136.00 | 136.00 | 192.00 | 4.00 | | 11.00 | | 100.00 | 69.00 |
| Ex. 8 | | | | | | | | | | | | |
| Com. | 45.00 | | 35.00 | 468.00 | | 164.00 | 8.00 | | 67.00 | | 107.00 | 6.00 |
| Ex. 9 | | | | | | | | | | | | |

TABLE 2

| | Designed Value | | | Analytical Value | | | |
|---|---|---|---|---|---|---|---|
| | Hydroxyl | Acid Value | Content of | Number | | | |
| | Value of | of Solid | Polyfunctional | Average | | Particle | |
| | Solid | Content | Monomer | Molecular | NV | Diameter | Viscosity |
| | Content | (mgKOH/g) | (% by weight) | Weight | (%) | (nm) | (mPa · s) |
| Pro. Ex. 1 | 140 | 30 | 0.22 | 5000 | 45 | 190 | 5000 |
| Pro. Ex. 2 | 140 | 30 | 0.44 | 5000 | 45 | 180 | 6500 |
| Pro. Ex. 3 | 110 | 30 | 0.44 | 5000 | 45 | 210 | 5500 |
| Pro. Ex. 4 | 180 | 30 | 0.44 | 5000 | 45 | 170 | 6000 |
| Pro. Ex. 5 | 130 | 15 | 0.22 | 5000 | 45 | 250 | 5000 |
| Pro. Ex. 6 | 130 | 24 | 0.89 | 5000 | 45 | 200 | 2500 |
| Com. Ex. 1 | 140 | 30 | 0.00 | No Synthesis | | | |
| Com. Ex. 2 | 140 | 30 | 0.44 | No Synthesis | | | |
| Com. Ex. 3 | 140 | 30 | 0.44 | 5000 | 45 | 120 | 25000 |
| Com. Ex. 4 | 140 | 30 | 5.00 | 7500 | 45 | 190 | 15000 |
| Com. Ex. 5 | 140 | 30 | 0.00 | 4800 | 45 | 220 | 3000 |
| Com. Ex. 6 | 140 | 30 | 0.44 | 20000 | 45 | 215 | 45000 |
| Com. Ex. 7 | 250 | 30 | 0.44 | 5000 | 45 | 170 | 8500 |
| Com. Ex. 8 | 140 | 60 | 0.44 | 5000 | 45 | 150 | 7500 |

| | | | | |
|---|---|---|---|---|
| Com. Ex. 9 | 130 | 5 | 0.89 | No Synthesis |

*Abbreviation:
Pro. Ex. stands for “Production Example”.
Com. Ex. stands for “Comparative Example”.

Abbreviations in Table 1 are as follows.

ST styrene

MMA methyl methacrylate

nBA butyl acrylate

nBMA butyl methacrylate

IBOMA isobornyl methacrylate

HEMA hydroxyethyl methacrylate

EGDM ethylene glycol dimethacrylate

AA acrylic acid

### Production Example 2

### Production of Water Dispersible Rein 2

A water dispersible resin 2 was produced in the same procedures as Production Example 1, except for compositions of monomer mixtures 1 and 2. The compositions of the monomer mixtures 1 and 2 were as shown in Table 1. Designed values of the water dispersible resin 2 were the same as those of the water dispersible resin 1. The water dispersible resin 2 thus obtained had a nonvolatile content of 45% by weight, a viscosity of about 6,500 mPa·s (25° C., 1 rpm), a volume average particle diameter of 180 nm, and a number average molecular weight of 5,000 (Table 2).

### Production Example 3

### Production of Water Dispersible Resin 3

A water dispersible resin 3 was produced in the same procedures as Production Example 1, except for compositions of monomer mixtures 1 and 2. The compositions of the monomer mixtures 1 and 2 were as shown in Table 1. Designed values of the water dispersible resin 3 were such that an acid value of solid content was 30 mgKOH/g and a hydroxyl value of solid content was 110. The water dispersible resin 3 thus obtained had a nonvolatile content of 45% by weight, a viscosity of about 5,500 mPa·s (25° C., 1 rpm), a volume average particle diameter of 210 nm, and a number average molecular weight of 5,000 (Table 2).

### Production Example 4

### Production of Water Dispersible Resin 4

A water dispersible resin 4 was produced in the same procedures as Production Example 1, except for compositions of monomer mixtures 1 and 2. The compositions of the monomer mixtures 1 and 2 were as shown in Table 1. Designed values of the water dispersible resin 4 were such that an acid value of solid content was 30 mgKOH/g and a hydroxyl value of solid content was 180. The water dispersible resin 4 thus obtained had a nonvolatile content of 45% by weight, a viscosity of about 6,000 mPa·s (25° C., 1 rpm), a volume average particle diameter of 170 nm, and a number average molecular weight of 5,000 (Table 2).

### Production Example 5

### Production of Water Dispersible Resin 5

A water dispersible resin 5 was produced in the same procedures as Production Example 1, except for compositions of monomer mixtures 1 and 2. The compositions of the monomer mixtures 1 and 2 were as shown in Table 1. Designed values of the water dispersible resin 5 were such that an acid value of solid content was 15 mgKOH/g and a hydroxyl value of solid content was 130. The water dispersible resin 5 thus obtained had a nonvolatile content of 45% by weight, a viscosity of about 5,000 mPa·s (25° C., 1 rpm), a volume average particle diameter of 250 nm, and a number average molecular weight of 5,000 (Table 2).

### Production Example 6

### Production of Water Dispersible Resin 6

A water dispersible resin 6 was produced in the same procedures as Production Example 1, except for compositions of monomer mixtures 1 and 2. The compositions of the monomer mixtures 1 and 2 were as shown in Table 1. Designed values of the water dispersible resin 6 were such that an acid value of solid content was 24 mgKOH/g, a hydroxyl value of solid content was 130, and Tg was 45° C. The water dispersible resin 6 thus obtained had a nonvolatile content of 45% by weight, a viscosity of about 2,500 mPa·s (25° C., 1 rpm), a volume average particle diameter of 200 nm, and a number average molecular weight of 5,000 (Table 2).

### Production Example 7

### Production of Coloring Pigment

Four point five parts of a nonion/anion dispersant (product name: Disperbyk 190, manufactured by BYK-Chemmie), 4.5 parts of a defoaming agent (product name: Disperbyk 110, manufactured by BYK-Chemmie), 22.9 parts of deionized water, 57.5 parts of rutile titanium dioxide, and 14.4 parts of barium sulfate were premixed. A glass bead medium was added to a resultant mixture in a paint conditioner, and further mixed and dispersed at a room temperature until the grain size became not more than 5μm, so as to obtain a coloring pigment paste.

### Production Example 8

### Production of an Aqueous Coating Material for Intermediate Coating for 3 Wet

(Production of Carbodiimide Compound)

Three thousand nine hundred and thirty parts of 4,4-dicyclohexyl methane diisocyanate were reacted with 79 parts of 3-methyl-1-phenyl-2-phospholene-1-oxide as a carbodiimide catalyst, at 180° C. for 16 hours, so as to obtain a carbodiimide compound having four carbodiimide groups in its single molecule, and which has isocyanate groups at both ends.

Then, 1,296 parts of polyethylene glycol monomethyl ether in which a repeating unit of an oxiethylene group was 9 on an average, and 2 parts of dibutyl tin dilaurate were added to the carbodiimide compound and heated at 90° C. for 2 hours, so as to obtain a carbodiimide compound whose ends were an isocyanate group and a hydrophilic group.

To the carbodiimide compound thus obtained, 3000 parts of GP-3000 (product name, manufactured by Sanyo Kasei), in which averagely 16.7 mol of propyrene oxide were added to each of three hydroxyl groups of glycerine, were added and reacted at 90° C. for 6 hours, so as to obtain a reactant. It was observed, by IR, that the reactant had no isocyanate group. Then, 18,800 parts of deionized water were added to the reactant and stirred. As such, a water dispersion of the carbodiimide compound whose resin solid content was 30% by weight was obtained.

(Production of Water Dispersible Polyurethane Composition)

Polycarbonatediol of 0.26 parts by mol, which was obtained from 1,6-hexanediol having a number average molecular weight of 2,000, 1.0 part by mol of isophorone diisocyanate, and 0.36 parts by mol of dimethylol propionic acid, and with respect to the total amount of them, 39% by weight of N-methyl-2-pyrolidone were charged in a reaction flask. They were reacted in a nitrogen gas stream at 125° C. for 2 hours. After that, 0.47 parts by mol of triethylamine were added to the reaction flask and stirred for 1 hour, so as to obtain a prepolymer.

Then, 100 g of the prepolymer thus obtained were dropped, over 15 minutes, in 120 g of water in which 0.05 g of a silicon defoaming agent SE-21 (product name, Wacker Silicone Co., Ltd.) was dissolved. After that, 2.4 g of monoethanolamine were added thereto, and stirred at 40° C. until absorption due to isocyanate groups did not occur, which was measured by infrared absorption spectroscopy. As such, a water dispersible polyurethane composition containing 31.5% by weight of a nonvolatile content was obtained.

A number average molecular weight of polyurethane dispersed in the water dispersible polyurethane composition was 2,200 according to measurement by GPC analysis.

Measurement conditions of the number average molecular weight were as follows.

Column: TSK gel G4000, G3000, and G2000

Eluent: THF

Flow rate: 1.000 mL/min

Detection: UV (245 nm)

Standard substance: PST

(Production of Water Dispersible Acrylic Resin)

In a normal reaction vessel for producing normal acrylic resin emulsion, equipped with a stirrer, a thermometer, a dropping funnel, a reflux condenser, a nitrogen gas inlet pipe, and the like, 445 parts of deionized water and 5 g of Newcol 293 (product name, manufactured by Nippon Nyukazai Co., Ltd.) were charged and stirred. During the stirring, a temperature was increased to 75° C. Then, a monomer mixture solution (acid value of solid content: 10 mgKOH/g, hydroxyl value: 60) described below, 240 parts of deionized water, and 30 parts of Newcol 293 were mixed and a mixture thus obtained was emulsified by a homogenizer. A monomer pre-emulsion thus emulsified by the homogenizer was dropped in the reaction vessel over 3 hours while being stirred. Further, while the monomer pre-emulsion was being dropped, an aqueous solution that was prepared such that 1 part of APS (ammonium persulfate) as a polymerization initiator was dissolved in 50 parts of water was evenly dropped in the reaction vessel at a constant dropping speed, until the dropping of the monomer pre-emulsion was completed. After the monomer pre-emulsion was dropped, the reaction was continued at 80° C. for 1 hour, so as to obtain a reactant. The reactant was then cooled down. An aqueous solution that was prepared such that 2 parts of dimethylaminoethanol were dissolved in 20 parts of water was poured into the reactant, so that an aqueous resin emulsion containing 40.0% by weight of a nonvolatile content was obtained. Thus obtained resin emulsion was adjusted, by use of 30% aqueous solution of dimethylaminoethanol, so that a pH was 7.2.

(Composition of monomer mixture solution)

| | | |
|---|---|---|
| Methyl methacrylate | 119 | parts |
| Butyl acrylate | 231 | parts |
| Styrene | 62 | parts |
| 4-hydroxybutyl acrylate | 80 | parts |
| Methacrylic acid | 8 | parts |
| Ethylene glycol dimethacrylate | 20 | parts |

(Production of Water Soluble Acrylic Acid)

In a reaction vessel, 23.9 parts of dipropylene glycol methyl ether and 16.1 parts of propylene glycol methyl ether were added. While they were being mixed by stirring in a nitrogen gas stream, a temperature was increased to 120 ° C. Then, (i) a mixture solution containing 54.5 parts of acrylic acid ethyl, 12.5 parts of methyl methacrylate, 14.7 parts of 2-hydroxyethyl acrylate, 10.0 parts of styrene, and 8.5 parts of methacrylic acid, and (ii) an initiator solution containing 10.0 parts of dipropylene glycol methyl ether, and 2.0 parts of t-butyl peroxy-2-ethyl hexanoate were respectively dropped in the reaction vessel over 3 hours in parallel. After that, a reactant thus obtained was maturated at the same temperature for 0.5 hours.

Furthermore, an initiator solution containing 5.0 parts of dipropylene glycol methyl ether and 0.3 parts of t-butyl peroxy-2-ethyl hexanoate was dropped in the reaction vessel over 0.5 hours. After the initiator solution was dropped, a resultant obtained was matured at the same temperature for 1 hour.

After 16.1 parts of the solvent was distilled away under a reduced pressure (70 Torr) at 110° C. by a solvent removing device, 187.2 parts of deionized water and 8.8 parts of dimethylaminoethanol were added, so as to obtain a water soluble acrylic resin. The water soluble acrylic resin had a nonvolatile content of 31% by weight, a number average molecular weight of 27,000, an acid value of solid content of 56.2 mgKOH/g, a hydroxyl value of solid content of 70, and a viscosity of 15,000 mPa·s (measurement device: R-type series 500, conical rotary viscometer, manufactured by Toki Sangyo Co., Ltd., measurement condition: 1.34 degree cone, 1 rpm/25° C.).

(Production of Coloring Pigment Paste)

Nine point four parts of a nonion/anion dispersant (product name: Disperbyk 190, manufactured by BYK-Chemmie), 36.8 parts of deionized water, 34.5 parts of rutile titanium dioxide, 34.4 parts of barium sulfate, and 6 parts of talc were premixed. A glass bead medium was added to a resultant mixture in a paint conditioner, and further mixed and dispersed at a room temperature until the grain size became not more than 5 μm, so as to obtain a coloring pigment paste.

(Production of Curing Agent Combined Emulsion)

In a 10-litter stainless beaker equipped with a stirrer (product name: T. K. Robomix, manufactured by Tokushu Kika Kogyo Co., Ltd.), 1,876 parts of deionized water, 400 parts of reactive surfactant 20% aqueous solution (product name: Latemul PD-104, manufactured by Kao Corporation), 8 parts of Rongalit (formaldehyde sodium sulfoxylate) were charged, and the mixture was stirred until the Rongalit was dissolved.

While the mixture was being stirred at 2,000 rpm, a homogeneous mixture of 80 parts of styrene, 227 parts of methyl methacrylate, 393 parts of methyl acrylate, 549 parts of ethyl acrylate, 246 parts of 4-hydroxybutyl acrylate, 24 parts of methacrylic acid, 80 parts of ethylene glycol dimethacrylate and 667 parts of a melamine resin (product name: CYMEL 211, solid content=80% by weight, methoxy/butoxy ratio=65/35, water compatibility=8 mL/g, xylene compatibility>100 mL/g, manufactured by Nihon Cytec Industries Inc.) was gradually added to the mixture, so as to obtain a primary emulsion. The primary emulsion was emulsified at 12,000 rpm for 20 minutes while being cooled with ice water. Then, a volume average particle diameter of a resultant obtained was measured (product name: ELS-800, manufactured by Otsuka Electronics Co., Ltd.). The volume average particle diameter of a pre-emulsion thus obtained was 154 nm.

Then, in a 5-litter vertically long flask equipped with a stirrer, a thermometer, a cooling tube, a nitrogen gas introducing tube and a water bath, 758 parts of the pre-emulsion was charged and stirred at 150 rpm. While the pre-emulsion was being stirred, a temperature was increased to 40° C. Then, 15 parts of an aqueous initiator solution, in which 80 parts of deionized water and 8 parts of 70% aqueous solution of t-butyl hydroxide (product name: Kayabutyl H-70, manufactured by Kayaku Akzo Co., Ltd.), were added to the pre-emulsion, so as to initiate polymerization. After the temperature was maintained at 40° C. for 10 minutes, 3,792 parts of the residual pre-emulsion and 73 parts of the initiator aqueous solution were respectively dropped over 3 hours in parallel.

After the dropping of the pre-emulsion and the aqueous initiator solution was completed, the temperature was maintained at 40° C. for 2 hours. Then, 51 parts of 25% aqueous solution of DMEA (dimethylaminoethanol) was dropped thereto over 30 minutes. After the dropping of the DMEA aqueous solution was completed, the temperature was also maintained at 40° C. for 1 hour. After that, a resultant obtained was cooled to a room temperature, and filtered by use of a 400 mesh filter so that emulsion was collected. The emulsion thus obtained was such that a nonvolatile content of was 45.5% by weight, a pH was 8.6, and a volume average particle diameter was 256 nm.

(Production of Aqueous Curable Resin Composition)

After 27.5 parts (as a basis of the solid content) of the obtained water dispersible acrylic resin composition and 5 parts (as a basis of the solid content) of the obtained water soluble acrylic resin were mixed with, as a curing agent, 12.5 parts (as a basis of the solid content) of a melamine resin (product name: CYMEL 211, solid content=80% by weight, methoxy/butyl ratio=65/35, water compatibility=8 mL/g, xylene compatibility>100 mL/g, manufactured by Nihon Cytec Industries Inc.), 0.3 parts of urethane association thickener (product name: ADEKANOL UH814N, manufactured by Asahi Denka Corporation) was mixed with them and stirred, so as to obtain an aqueous curable resin composition. The aqueous curable resin composition thus obtained was diluted with deionized water so that a nonvolatile content (NV) of the aqueous curable resin composition was 36% by weight.

### Comparative Production Example 1

### Production of Water Dispersible Resin 7

Experiments on Examples disclosed in Patent Document 1 were carried out.

In a reaction vessel, 135 parts of MP was charged and stirred. During the stirring, a temperature was increased to 120° C. After that, a monomer mixture 1 having a composition shown in Table 1 was dropped in the reaction vessel over 1.5 hours while being stirred. While the monomer mixture 1 was being dropped, a polymerization initiator solution that was prepared such that 22 parts of Kayaester O was dissolved in 100 parts of MP was evenly dropped in the reaction vessel until the dropping of the monomer mixture 1 was completed. After the monomer mixture 1 was dropped, a reaction was further continued at 120° C. However, a resulted reactant was turned into gel in the middle of the reaction, and a water dispersible resin 7 could not be obtained.

### Comparative Production Example 2

### Production of Water Dispersible Resin 8

An experiment of producing a water dispersible resin 8 was carried out in the same procedures as Comparative Example 1, except for a composition of a monomer mixture 1. The composition of the monomer mixture 1 was shown in Table 1. As a result, after dropping of the monomer mixture 1 was completed, a reaction was further continued at 120° C. However, a resulted reactant was turned into gel in the middle of the reaction, and a water dispersible resin 8 could not be obtained.

### Comparative Production Example 3

### Production of Water Dispersible Resin 9

In a reaction vessel, 675 parts of MP was charged and stirred. During the stirring, a temperature was increased to 120° C. After the temperature was increased, a monomer mixture 1 shown in Table 1 was dropped in the reaction vessel over 3 hours while being stirred. While the monomer mixture 1 was being dropped, a polymerization initiator solution that was prepared such that 27 parts of Kayaester O was dissolved in 180 parts of MP was evenly dropped in the reaction vessel until the dropping of the monomer mixture 1 was completed.

After the monomer mixture 1 was dropped, a reaction was further continued at 120° C. for 2 hours. After that, a reactant thus obtained was cooled down to 90° C., and 81 parts of PnB was added thereto. Then, a pressure was reduced so that 855 parts of MP was distilled away. After the pressure was increased to a normal pressure, 81 parts of Solvent naphtha 100, 12 parts of dimethylethanolamine, 37 parts of triethanolamine were added to the reactant and mixed evenly. Then, a resultant obtained was dispersed in 888 parts of water so as to obtain a water dispersible resin 9. Designed values of the water dispersible resin 9 were the same as those of the water dispersible resin 1. The water dispersible resin 9 thus obtained was such that a nonvolatile content (NV) was 45% by weight, a viscosity was about 25,000 mPa·s (25° C., 1 rpm), a volume average particle diameter was 120 nm, and a number average molecular weight was 5,000 (Table 2).

### Comparative Production Example 4

### Production of Water Dispersible Resin 10

In a reaction vessel, 675 parts of MP was charged and stirred. During the stirring, a temperature was increased to 120° C. After that, a monomer mixture 1 shown in Table 1 was dropped in the reaction vessel over 1.5 hours while being stirred. While the monomer mixture 1 was being dropped, a polymerization initiator solution that was prepared such that 22 parts of Kayaester O was dissolved in 145 parts of MP was evenly dropped in the reaction vessel until the dropping of the monomer mixture 1 was completed.

After the monomer mixture 1 was dropped, the reaction was further continued at 120° C. for 1 hour. During the reaction, a monomer mixture 2 having a composition shown in Table 1 was dropped in the reaction vessel over 1 hour while being stirred. At this time, in the similar manner that the monomer mixture 1 was dropped, while the monomer mixture 2 was being dropped, a polymerization initiator solution that was prepared such that 5 parts of Kayaester O was dissolved in 36 parts of MP was evenly dropped in the reaction vessel. The dropping of the solution was continued until the dropping of the monomer mixture 2 was completed.

After the monomer mixture 2 was dropped, the reaction was further continued at 120° C. for 2 hours. After that, a reactant obtained was cooled down to 90° C., and 81 parts of propylene glycol monobutyl ether (hereinafter, referred to as PnB) were added to the reactant. Then, a pressure was reduced so that 856 g of MP were distilled away. After the pressure was increased to a normal pressure, 81 parts of Solvent naphtha 100, 12 parts of dimethylethanolamine, 37 parts of triethanolamine were added to the reactant and mixed evenly. Then, a resultant obtained was dispersed in 888 parts of water, so as to obtain a water dispersible resin 10.

Designed values of the water dispersible resin 10 were such that an acid value of solid content was 30 mgKOH/g, and a hydroxyl value of solid content was 140. The water dispersible resin 10 thus obtained had a nonvolatile content of 45% by weight, a viscosity of about 15,000 mPa·s (25° C., 1 rpm), a volume average particle diameter of 190 nm, and a number average molecular weight of 7,500 (Table 2).

### Comparative Production Example 5

### Production of Water Dispersible Resin 11

A water dispersible resin 11 was produced in the same procedures as Comparative Production Example 4, except for compositions of monomer mixtures 1 and 2. The compositions of the monomer mixtures 1 and 2 were as shown in Table 1. Designed values of the water dispersible resin 11 were such that an acid value of solid content was 30 mgKOH/g, and a hydroxyl value was 140. The water dispersible resin 11 thus obtained had a nonvolatile content of 45% by weight, a viscosity of about 3,000 mPa·s (25° C., 1 rpm), a volume average particle diameter of 220 nm, and a number average molecular weight of 4,800 (Table 2).

### Comparative Production Example 6

### Production of Water Dispersible Resin 12

A water dispersible resin 12 was produced in the same procedures as Comparative Production Example 4, except for the following points. That is, 250 parts of MP was charged in a reaction vessel at the beginning, and 4 parts and 1 part of Kayaester O were respectively dropped while monomer mixtures 1 and 2 were dropped. Compositions of the monomer mixtures 1 and 2 were as shown in Table 1. Designed values of the water dispersible resin 12 were such that an acid value of solid content was 30 mgKOH/g, and a hydroxyl value was 140. The water dispersible resin 12 thus obtained had a nonvolatile content of 45% by weight, a viscosity of about 45,000 mPa·s (25° C., 1 rpm), a volume average particle diameter of 215 nm, and a number average molecular weight of 20,000 (Table 2).

### Comparative Production Example 7

### Production of Water Dispersible Resin 13

A water dispersible resin 13 was produced in the same procedures as Comparative Production Example 4, except for compositions of monomer mixtures 1 and 2. The compositions of the monomer mixtures 1 and 2 were as shown in Table 1. Designed values of the water dispersible resin 13 were such that an acid value of solid content was 30 mgKOH/g, and a hydroxyl value was 250. The water dispersible resin 13 thus obtained had a nonvolatile content of 45% by weight, a viscosity of about 8,500 mPa·s (25° C., 1 rpm), a volume average particle diameter of 170 nm, and a number average molecular weight of 5,000 (Table 2).

### Comparative Production Example 8

### Production of Water Dispersible Resin 14

A water dispersible resin 14 was produced in the same procedures as Comparative Production Example 4, except for compositions of monomer mixtures 1 and 2. The compositions of the monomer mixtures 1 and 2 were as shown in Table 1. Designed values of the water dispersible resin 14 were such that an acid value of solid content was 60 mgKOH/g, and a hydroxyl value was 140. The water dispersible resin 14 thus obtained had a nonvolatile content of 45% by weight, a viscosity of about 7,500 mPa·s (25° C., 1 rpm), a volume average particle diameter of 150 nm, and a number average molecular weight of 5,000 (Table 2).

### Comparative Production Example 9

### Production of Water Dispersible Resin 15

An experiment to produce a water dispersible resin 15 in the same procedures as Comparative Production Example 4, except for compositions of monomer mixtures 1 and 2, was carried out. As a result of the experiment, after a solvent was removed, a homogeneous mixture of 81 parts of Solvent naphtha 100, 12 parts of dimethylethanolamine, and 37 parts of triethanolamine was dispersed in 888 parts of water. However, a good water dispersion could not be obtained.

### EXAMPLES

(Composition for Intermediate Coating)

### Examples 1 through 6, and Comparative Example 3 through 8

After 35.0 parts (as a basis of solid content) of the water dispersible resin 1 obtained in Production Example 1, 41.1 parts of the pigment paste obtained in Production Example 7, 0.3 parts of a surface conditioner (product name: Disperbyk 347, manufactured by BYK-Chemmie), and 1.7 parts of a defoaming agent (product name: Disperbyk 011, manufactured by BYK-Chemmie) were mixed together, 0.05 parts (as a basis of solid content) of urethane association thickener (product name: ADEKANOL UH814N, manufactured by Asahi Denka Corporation) was mixed with them and stirred. Then, a resultant mixture was mixed with 25.0 parts (as a basis of solid content) of a polyisocyanate-curing agent having water dispersibility (product name: Bayhydur VPLS-2319), so as to obtain a water dispersible aqueous curable resin composition of Example 1.

An equivalent ratio between a hydroxyl group and a polyisocyanate group in the water dispersible aqueous curable resin composition thus obtained in Example 1 was 1.0:1.2.

In the similar manner, Examples 2 through 6 and Comparative Examples 3 through 8 were carried out respectively by use of the water dispersible resins obtained in Production Example 2 through 6 and Comparative Production Example 3 through 8, so as to obtain water dispersible aqueous curable resin compositions of Examples 2 through 6, and Comparative Examples 3 through 8. Equivalent ratios between a hydroxyl group and a polyisocyanate group in these water dispersible aqueous curable resin compositions thus obtained are shown in Table 3.

TABLE 3

| | | | | | | | Degree | | |
|---|---|---|---|---|---|---|---|---|---|
| | | | | | | | of Surface | | |
| | | | | | | | Roughness | | |
| | Water | | Curing Agent | | | | of | | |
| | Dispersible | Pigment | With Water | Without Water | | Hydroxyl | Intermediate | Pot | Water |
| | Resin | Paste | Dispersibility | Dispersibility | Ratio | Group:NCO | Coating (Ra) | Life | Resistance |
| Ex. 1 | Pro. Ex. 1 | Pro. Ex. 7 | VPLS2319 | | | 1:1.2 | 0.19 | 5 hr | ◯ |
| Ex. 2 | Pro. Ex. 2 | | VPLS2319 | | | 1:1.2 | 0.20 | 5 hr | ◯ |
| Ex. 3 | Pro. Ex. 3 | | VPLS2319 | | | 1:1.6 | 0.19 | 5 hr | ◯ |
| Ex. 4 | Pro. Ex. 4 | | VPLS2319 | | | 1:1.0 | 0.19 | 5 hr | ◯ |
| Ex. 5 | Pro. Ex. 5 | | VPLS2319 | | | 1:1.3 | 0.21 | 3 hr | ◯ |
| Ex. 6 | Pro. Ex. 6 | | VPLS2319 | | | 1:1.3 | 0.21 | 4 hr | ◯ |
| Ex. 7 | Pro. Ex. 1 | | VPLS2319 | N3600 | 1:1 | 1:1.4 | 0.19 | 3 hr | ◯ |
| Com. Ex. 1 | Com. Pro. Ex. 1 | No Evaluation Carried Out | | | | | | | |
| Com. Ex. 2 | Com. Pro. Ex. 2 | No Evaluation Carried Out | | | | | | | |
| Com. Ex. 3 | Com. Pro. Ex. 3 | Pro. Ex. 7 | VPLS2319 | | | 1:1.2 | 0.22 | 0.5 hr | X |
| Com. Ex. 4 | Com. Pro. Ex. 4 | | VPLS2319 | | | 1:1.2 | 0.34 | 5 hr | ◯ |
| Com. Ex. 5 | Com. Pro. Ex. 5 | | VPLS2319 | | | 1:1.2 | 0.40 | 1 hr | X |
| Com. Ex. 6 | Com. Pro. Ex. 6 | | VPLS2319 | | | 1:1.2 | 0.37 | 5 hr | ◯ |
| Com. Ex. 7 | Com. Pro. Ex. 7 | | VPLS2319 | | | 1:0.7 | 0.27 | 1 hr | Δ |
| Com. Ex. 8 | Com. Pro. Ex. 8 | | VPLS2319 | | | 1:1.2 | 0.25 | 1 hr | X |

| | | |
|---|---|---|
| Com. Ex. 9 | Com. Pro. Ex. 9 | No Evaluation Carried Out |

*Abbreviation:
Ex. stands for “Example”.
Pro. Ex. stands for “Production Example”.
Com. Ex. stands for “Comparative Example”.
Com. Pro. Ex. stands for “Comparative Production Example”

### Example 7

After 35.0 parts (as a basis of solid content) of the water dispersible resin 1 obtained in Production Example 1, 41.1 parts of the pigment paste obtained in Production Example 7, 0.3 parts of a surface conditioner (product name: Disperbyk 347, manufactured by BYK-Chemmie), and 1.7 parts of a defoaming agent (product name: Disperbyk 011, manufactured by BYK-Chemmie) were mixed together, 0.05 parts (as a basis of solid content) of urethane association thickener (product name: ADEKANOL UH814N, manufactured by Asahi Denka Corporation) was mixed with them and stirred. Then, a resultant mixture was mixed with 12.5 parts of a polyisocyanate-curing agent having water dispersibility (product name: Bayhydur VPLS-2319) and 12.5 parts (as a basis of solid content) of a polyisocyanate having no water dispersibility (product name: N3600, manufactured by Sumika Bayer Urethane Co., Ltd.), so as to obtain a water dispersible aqueous curable resin composition.

In regard to Comparative Examples 1, 2, and 9, since synthesis could not be carried out in Comparative Production Examples 1, 2, and 9, water dispersible aqueous curable resin compositions were not produced.

(Preparation of Sample of Intermediate Coating Film)

A cationic electrodeposition coating (product name: Powertop U-50, manufactured by Nippon Paint Co., Ltd) was applied by electrodeposition to a dull steel plate (300×400×0.8 mm) treated with zinc phosphate so that a film thickness of a dried film was 20 μm, and cured by heating at 160° C. for 30 minutes. As such an electrodeposition plate was prepared.

A composition for intermediate coating was applied, by air spraying, to the plate thus obtained so as to be 30 μm in thickness, and preheated at 80° C. for 5 minutes. Then, the composition for intermediate coating thus applied was cured by heating at 140° C. for 30 minutes, so as to obtain a sample on which a coating film was formed.

(Evaluation of Samples of Intermediate Coating Film)

With the use of the water dispersible resin compositions thus obtained, pot lives thereof were evaluated. Further, with the use of samples obtained according to the above manner, appearances thereof were evaluated. Results are shown in Table 3.

<Degree of Surface Roughness of Intermediate Coating (Ra)>

A degree of surface roughness (roughness curve: Ra) of an intermediate coating was measured under a condition in which a cutoff value was 2.5 mm, by use of a surface roughness tester (SJ-201P, manufactured by Mitsutoyo Corporation).

<Pot Life>

Firstly, an aqueous composition for intermediate coating immediately after preparation was observed. Then, at a room temperature, the aqueous composition for intermediate coating was observed every ¼ hour, and compared with a result of the observation of the aqueous composition for intermediate coating immediately after preparation. As such a pot life was evaluated based on the following criteria. A period of time until the aqueous composition for intermediate coating became “cross” was regarded as a pot life property.

Single circles mean “In comparison of the aqueous composition for intermediate coating immediately after preparation, it was not observed that a viscosity decreased or increased, and an appearance of the coating film was deteriorated”.

Crosses means “In comparison of the aqueous composition for intermediate coating immediately after preparation, it was observed that a viscosity decreased or increased, and an appearance of the coating film was deteriorated”.

<Water Resistance>

The samples were immersed in warm water of 40° C. for 10 days. After that, the samples were washed for 1 hour, and then appearances of the samples were observed with eyes, and evaluated based on the following criteria. The aqueous compositions for intermediate coating evaluated as “double circle” or “single circle” did not have any problems for practical use.

Double circles mean “No change”.

Single circles mean “A part immersed in warm water was slightly swollen but restored rapidly”.

Triangles mean “A part immersed in warm water was slightly swollen and it took time that the part restored”.

Crosses mean “A part immersed in warm water was significantly swollen and it took long time that the part restored”.

(Composition for Base Coating)

### Examples 8 through 13, Comparative Examples 12 through 17

After 35.0 parts (as a basis of solid content) of the water dispersible resin 1 obtained in Production Example 1, 8.0 parts (as a basis of solid content) of an aluminum pigment paste (STAPA HYDROLAN 9157, manufactured by ECKART), 0.3 parts of a surface conditioner (product name: Disperbyk 347, manufactured BYK-Chemmie), and 1.7 parts of a defoaming agent (product name: Disperbyk 011, manufactured by BYK-Chemmie) were mixed together, 0.05 parts (as a basis of solid content) of urethane association thickener (product name: ADEKANOL UH814N, manufactured by Asahi Denka Corporation) was mixed with them and stirred. After that, a resultant mixture was mixed with 25.0 parts of a polyisocyanate-curing agent having water dispersibility (product name: Bayhydur VPLS-2319), so as to obtain a water dispersible aqueous curable resin composition of Example 8.

An equivalent ratio between a hydroxyl group and a polyisocyanate group in the water dispersible aqueous curable resin composition obtained in Example 8 was 1.0:1.2.

In the similar manner, Examples 9 through 13 and Comparative Examples 12 through 17 were carried out respectively by use of the water dispersible resins obtained in Production Example 2 through 6 and Comparative Production Example 3 through 8, so as to obtain water dispersible aqueous curable resin compositions of Examples 9 through 13, and Comparative Examples 12 through 17. Equivalent ratios between a hydroxyl group and a polyisocyanate group in these water dispersible aqueous curable resin compositions thus obtained are shown in Table 4.

TABLE 4

| | | | | | | | Degree of Surface | |
|---|---|---|---|---|---|---|---|---|
| | Water | | Curing Agent | | | | Roughness of | |
| | Dispersible | Aluminum | With Water | Without Water | | Hydroxyl | Intermediate | Pot |
| | Resin | Paste | Dispersibility | Dispersibility | Ratio | Group:NCO | Coating (Ra) | Life |
| Ex. 8 | Pro. Ex. 1 | HYDROLAN | VPLS2319 | | | 1:1.2 | 0.31 | 3 hr |
| Ex. 9 | Pro. Ex. 2 | 9157 | VPLS2319 | | | 1:1.2 | 0.31 | 3 hr |
| Ex. 10 | Pro. Ex. 3 | | VPLS2319 | | | 1:1.6 | 0.32 | 3 hr |
| Ex. 11 | Pro. Ex. 4 | | VPLS2319 | | | 1:1.0 | 0.32 | 3 hr |
| Ex. 12 | Pro. Ex. 5 | | VPLS2319 | | | 1:1.3 | 0.35 | 2 hr |
| Ex. 13 | Pro. Ex. 6 | | VPLS2319 | | | 1:1.3 | 0.35 | 2 hr |
| Ex. 14 | Pro. Ex. 1 | | VPLS2319 | N3600 | 1:1 | 1:1.4 | 0.32 | 2 hr |
| Com. Ex. 10 | Com. Pro. Ex. 1 | No Evaluation Carried Out | | | | | | |
| Com. Ex. 11 | Com. Pro. Ex. 2 | No Evaluation Carried Out | | | | | | |
| Com. Ex. 12 | Com. Pro. Ex. 3 | HYDROLAN | VPLS2319 | | | 1:1.2 | 0.40 | 0.25 hr |
| Com. Ex. 13 | Com. Pro. Ex. 4 | 9157 | VPLS2319 | | | 1:1.2 | 0.45 | 1 hr |
| Com. Ex. 14 | Com. Pro. Ex. 5 | | VPLS2319 | | | 1:1.2 | 0.50 | 0.5 hr |
| Com. Ex. 15 | Com. Pro. Ex. 6 | | VPLS2319 | | | 1:1.2 | 0.55 | 1 hr |
| Com. Ex. 16 | Com. Pro. Ex. 7 | | VPLS2319 | | | 1:0.7 | 0.39 | 0.5 hr |
| Com. Ex. 17 | Com. Pro. Ex. 8 | | VPLS2319 | | | 1:1.2 | 0.37 | 0.5 hr |

| | | |
|---|---|---|
| Com. Ex. 18 | Com. Pro. Ex. 9 | No Evaluation Carried Out |

*Abbreviation:
Ex. stands for “Example”.
Pro. Ex. stands for “Production Example”.
Com. Ex. stands for “Comparative Example”.
Com. Pro. Ex. stands for “Comparative Production Example”

### Example 14

After 35.0 parts (as a basis of solid content) of the water dispersible resin 1 obtained in Production Example 1, 8.0 parts (as a basis of solid content) of an aluminum pigment paste (STAPA HYDROLAN 9157, manufactured by ECKART), 0.3 parts of a surface conditioner (product name: Disperbyk 347, manufactured by BYK-Chemmie), and 1.7 parts of a defoaming agent (product name: Disperbyk 011, manufactured by BYK-Chemmie) were mixed together, 0.05 parts (as a basis of solid content) of urethane association thickener (product name: ADEKANOL UH814N, manufactured by Asahi Denka Corporation) was mixed with them and stirred. After that, a resultant mixture was mixed with 12.5 parts (as a basis of solid content) of a polyisocyanate-curing agent having water dispersibility (product name: Bayhydur VPLS-2319) and 12.5 parts (as a basis of solid content) of a polyisocyanate having no water dispersibility (product name: N3600, manufactured by Sumika Bayer Urethane Co., Ltd.), so as to obtain a water dispersible aqueous curable resin composition.

In regard to Comparative Examples 10, 11, and 18, since synthesis could not be carried out in Comparative Production Examples 1, 2, and 9, water dispersible aqueous curable resin compositions could not be produced.

Preparation of Sample of Base Coating Film)

A cationic electrodeposition coating (product name: Powertop U-50, manufactured by Nippon Paint Co., Ltd) was applied by electrodeposition to a dull steel plate (300'400×0.8 mm) treated with zinc phosphate so that a film thickness of a dried film was 20 μm, and cured by heating at 160° C. for 30 minutes. As such an electrodeposition plate was prepared.

A composition for base coating was applied, by air spraying, to the plate thus obtained so as to be 15 μm in thickness, and preheated at 80° C. for 5 minutes. Then, the composition for base coating thus applied was cured by heating at 140° C. for 30 minutes, so as to obtain a sample on which a coating film was formed.

Evaluation of Samples of Base Coating Film

With the use of the water dispersible resin compositions thus obtained, pot lives thereof were evaluated. Further, with the use of samples obtained according to the above manner, appearances thereof were evaluated. Results are shown in Table 4.

<Degree of Surface Roughness of Base Coating (Ra)>

A degree of surface roughness (roughness curve: Ra) of a base coating was measured under a condition in which a cutoff value was 2.5 mm, by use of a surface roughness tester (SJ-201P, manufactured by Mitsutoyo Corporation).

<Pot Life>

Firstly, an aqueous composition for base coating immediately after preparation was observed. Then, at a room temperature, the aqueous composition for base coating was observed every ¼ hour, and compared with a result of observation of the aqueous composition for base coating immediately after preparation. As such, a pot life was evaluated based on the following criteria. A period of time until the aqueous composition for base coating became “cross” was regarded as a pot life property.

Single circles mean “In comparison of the aqueous composition for base coating immediately after preparation, it was not observed that a viscosity decreased or increased, and an appearance of the coating film was deteriorated”.

Crosses mean “In comparison of the aqueous composition for base coating immediately after preparation, it was observed that a viscosity decreased or increased, and an appearance of the coating film was deteriorated”.

Clear Coating Composition

### Examples 15 through 20, Comparative Examples 21 through 26

After 35.0 parts (as a basis of solid content) of the water dispersible resin 1 obtained in Production Example 1, 0.3 parts of a surface conditioner (product name: Disperbyk 347, manufactured by BYK-Chemmie), and 1.7 parts of a defoaming agent (product name: Disperbyk 011, manufactured by BYK-Chemmie) were mixed together, 0.05 parts (as a basis of solid content) of urethane association thickener (product name: ADEKANOL UH814N, manufactured by Asahi Denka Corporation) was mixed with them and stirred. Then, a resultant mixture was mixed with 25.0 parts (as a basis of solid content) of a polyisocyanate-curing agent having water dispersibility (product name: Bayhydur VPLS-2319), so as to obtain a water dispersible aqueous curable resin composition of Example 15. An equivalent ratio between a hydroxyl group and a polyisocyanate group in the water dispersible aqueous curable resin composition obtained in Example 15 was 1.0:1.2.

In the similar manner, Examples 16 through 20 and Comparative Examples 21 through 26 were carried out respectively by use of the water dispersible resins obtained in Production Example 2 through 6 and Comparative Production Example 3 through 8, so as to obtain water dispersible aqueous curable resin compositions of Examples 16 through 20, and Comparative Examples 21 through 26. Equivalent ratios between a hydroxyl group and a polyisocyanate group in these water dispersible aqueous curable resin compositions thus obtained are shown in Table 5.

TABLE 5

| | | Curing Agent | | | | Degree of Surface | |
|---|---|---|---|---|---|---|---|
| | Water | With Water | Without Water | | Hydroxyl Group: | Roughness of Clear | |
| | Dispersible Resin | Dispersibility | Dispersibility | Ratio | NCO | Coating (Ra) | Pot Life |
| Ex. 15 | Pro. Ex. 1 | VPLS2319 | | | 1:1.2 | 0.10 | 5 hr |
| Ex. 16 | Pro. Ex. 2 | VPLS2319 | | | 1:1.2 | 0.11 | 5 hr |
| Ex. 17 | Pro. Ex. 3 | VPLS2319 | | | 1:1.6 | 0.12 | 5 hr |
| Ex. 18 | Pro. Ex. 4 | VPLS2319 | | | 1:1.0 | 0.11 | 5 hr |
| Ex. 19 | Pro. Ex. 5 | VPLS2319 | | | 1:1.3 | 0.11 | 5 hr |
| Ex. 20 | Pro. Ex. 6 | VPLS2319 | | | 1:1.3 | 0.12 | 5 hr |
| Ex. 21 | Pro. Ex. 1 | VPLS2319 | N3600 | 1:1 | 1:1.4 | 0.13 | 5 hr |
| Com. Ex. 19 | Com. Pro. Ex. 1 | No Evaluation Carried Out | | | | | |
| Com. Ex. 20 | Com. Pro. Ex. 2 | No Evaluation Carried Out | | | | | |
| Com. Ex. 21 | Com. Pro. Ex. 3 | VPLS2319 | | | 1:1.2 | 0.15 | 1 hr |
| Com. Ex. 22 | Com. Pro. Ex. 4 | VPLS2319 | | | 1:1.2 | 0.30 | 5 hr |
| Com. Ex. 23 | Com. Pro. Ex. 5 | VPLS2319 | | | 1:1.2 | 0.23 | 1 hr |
| Com. Ex. 24 | Com. Pro. Ex. 6 | VPLS2319 | | | 1:1.2 | 0.30 | 5 hr |
| Com. Ex. 25 | Com. Pro. Ex. 7 | VPLS2319 | | | 1:0.7 | 0.17 | 1 hr |
| Com. Ex. 26 | Com. Pro. Ex. 8 | VPLS2319 | | | 1:1.2 | 0.25 | 1 hr |

| | | |
|---|---|---|
| Com. Ex. 27 | Com. Pro. Ex. 9 | No Evaluation Carried Out |

*Abbreviation:
Ex. stands for “Example”.
Pro. Ex. stands for “Production Example”.
Com. Ex. stands for “Comparative Example”.
Com. Pro. Ex. stands for “Comparative Production Example”

### Example 21

After 35.0 parts (as a basis of solid content) of the water dispersible resin 1 obtained in Production Example 1, 0.3 parts of a surface conditioner (product name: Disperbyk 347, manufactured by BYK-Chemmie), and 1.7 parts of a defoaming agent (product name: Disperbyk 011, manufactured by BYK-Chemmie) were mixed together, 0.05 parts (as a basis of solid content) of urethane association thickener (product name: ADEKANOL UH814N, manufactured by Asahi Denka Corporation) was mixed with them and stirred. Then, a resultant mixture was mixed with 12.5 parts (as a basis of solid content) of a polyisocyanate-curing agent having water dispersibility (product name: Bayhydur VPLS-2319) and 12.5 parts of a polyisocyanate having no water dispersibility (product name: N3600, manufactured by Sumika Bayer Urethane Co., Ltd.), so as to obtain a water dispersible aqueous curable resin composition.

In regard to Comparative Examples 19, 20, and 27, since synthesis could not be carried out in Comparative Production Examples 1, 2, and 9, water dispersible aqueous curable resin compositions could not be produced.

(Preparation of Samples of Clear Coating Film)

A cationic electrodeposition coating (product name: Powertop U-50, manufactured by Nippon Paint Co., Ltd) was applied by electrodeposition to a dull steel plate (300×400×0.8 mm) treated with zinc phosphate so that a film thickness of a dried film was 20 μm, and cured by heating at 160° C. for 30 minutes. As such an electrodeposition plate was prepared.

An aqueous clear coating composition was applied, by air spraying, to the plate thus obtained so as to be 30 μm in thickness, and preheated at 80° C. for 5 minutes. Then, the aqueous clear coating composition thus applied was cured by heating at 140° C. for 30 minutes, so as to obtain a sample on which a coating film was formed.

(Evaluation of Sample of Clear Coating Film)

With the use of the water dispersible resin compositions thus obtained, pot lives thereof were evaluated. Further, with the use of samples obtained according to the above manner, appearances thereof were evaluated. Results are shown in Table 5.

<Degree of Surface Roughness of Clear Coating (Ra)>

A degree of surface roughness (roughness curve: Ra) of a clear coating was measured under a condition in which a cutoff value was 2.5 mm, by use of a surface roughness tester (SJ-201P, manufactured by Mitsutoyo Corporation).

<Pot Life>

Firstly, an aqueous clear coating composition immediately after preparation was observed. Then, at a room temperature, the aqueous clear coating composition was observed every ¼ hour, and compared with a result of observation of the aqueous clear coating composition immediately after preparation. As such a pot life was evaluated based on the following criteria. A period of time until the aqueous clear coating composition became “cross” was regarded as a pot life property.

Single circles mean “In comparison of the aqueous clear coating composition immediately after preparation, it was not observed that a viscosity decreased or increased, and an appearance of the coating film was deteriorated”.

Crosses mean “In comparison of the aqueous clear coating composition immediately after preparation, it was observed that a viscosity decreased or increased, and an appearance of the coating film was deteriorated”.

As shown in results of Examples 7, 14, and 21, it was not necessary that all the polyisocyanates as a curing agent had water dispersibility. Even when a half of the polyisocyanates did not have water dispersibility, a good pot life property could be obtained in the coexistence with the aforementioned water dispersible resins.

(Forming of Multilayer Coating Film, Case 1 (a Case Where an Intermediate Coating was Formed from a Two-Component Thermosetting Resin Composition))

### Examples 22 through 28, and Comparative Examples 30 through 35

A cationic electrodeposition coating (product name: Powertop U-50, manufactured by Nippon Paint Co., Ltd) was applied by electrodeposition to a dull steel plate treated with zinc phosphate so that a film thickness of a dried film was 20 μm, cured by heating at 160° C. for 30 minutes, and then cooled down. As such a steel plate substrate was prepared.

The aqueous compositions for intermediate coating obtained in Examples 1 through 7, and Comparative Examples 3 through 8 were applied, by air spraying, respectively to steel plate substrates obtained according to the aforementioned manner so that coating films formed thereon were 20 μm in thickness, and preheated at 80° C. for 5 minutes. Then, an aqueous metallic composition for base coating (product name: Aquarex AR-2000 silver metallic, manufactured by Nippon Paint Co., Ltd.) was applied, by air spraying, to a respective of the steel plate substrates so that coating films formed thereon were 15 μm in thickness, and preheated at 80° C. for 3 minutes. After that, an acid epoxy curable clear coating composition (product name: Macflow O-1800W-2 clear, manufactured by Nippon Paint Co., Ltd.), as a clear coating material, was applied, by air spraying, to a respective of the steel plate substrates thus coated so that coating films formed thereon were 35 μm in thickness, and cured by heating at 140° C. for 30 minutes. As such samples, on each of which a multilayer coating film was formed, were obtained.

In regard to Comparative Examples 28, 29, and 36, since synthesis could not be carried out in Comparative Production Examples 1, 2, and 9, such samples could not be produced.

(Forming of Multilayer Coating Film, Case 2 (a Case where a Clear Coating was Formed from a Two-Component Thermosetting Resin Composition))

### Examples 29 through 35, and Comparative Examples 39 through 44

A cationic electrodeposition coating (product name: Powertop U-50, manufactured by Nippon Paint Co., Ltd) was applied by electrodeposition to a dull steel plate treated with zinc phosphate so that a film thickness of a dried film was 20 μm, cured by heating at 160° C. for 30 minutes, and then cooled down. As such a steel plate substrate was prepared.

The aqueous composition for intermediate coating for 3-wet obtained in Production Example 8 was applied, by air spraying, to steel plate substrates obtained according to the aforementioned manner so that coating films formed thereon were 20 μm in thickness, and preheated at 80° C. for 5 minutes. Then, an aqueous metallic composition for base coating (product name: Aquarex AR-2000 silver metallic, manufactured by Nippon Paint Co., Ltd.) was applied, by air spraying, to a respective of the steel plate substrates thus coated so that coating films formed thereon was 15 μm in thickness, and preheated at 80° C. for 3 minutes. After that, the clear coating compositions obtained in Examples 15 through 22, and Comparative Examples 21 through 26, as a clear coating material, were applied, by air spraying, to a respective of the steel plate substrates so that coating films formed thereon were 30 μm in thickness, and cured by heating at 140° C. for 30 minutes. As such samples, on each of which a multilayer coating film was formed, were obtained.

In regard to Comparative Examples 37, 38, and 45, since synthesis could not be carried out in Comparative Production Examples 1, 2, and 9, such samples could not be produced.

(Evaluation on Samples of Multilayer Coating Film)

With the use of the samples thus obtained, appearances and water resistance thereof were evaluated. Results of the evaluation are shown in Tables 6 and 7.

TABLE 6

| | Intermediate Coating | | | | | | | |
|---|---|---|---|---|---|---|---|---|
| | Water | | | | | | | Pot Life of |
| | Dispersible | | Base | Clear | Appearance | | Water | Intermediate |
| | Resin | Examples | Coating | Coating | LW | SW | Resistance | Coating |
| Ex. 22 | Pro. Ex. 1 | Ex. 1 | AR-2000 | MAC-O- | 5 | 15 | ◯ | 5 hr |
| Ex. 23 | Pro. Ex. 2 | Ex. 2 | Silver | 1800W | 5 | 16 | ◯ | 5 hr |
| Ex. 24 | Pro. Ex. 3 | Ex. 3 | Metallic | | 5 | 16 | ◯ | 5 hr |
| Ex. 25 | Pro. Ex. 4 | Ex. 4 | | | 5 | 16 | ◯ | 5 hr |
| Ex. 26 | Pro. Ex. 5 | Ex. 5 | | | 6 | 17 | ◯ | 3 hr |
| Ex. 27 | Pro. Ex. 6 | Ex. 6 | | | 6 | 17 | ◯ | 4 hr |
| Ex. 28 | Pro. Ex. 1 | Ex. 6 | | | 5 | 15 | ◯ | 3 hr |
| Com. Ex. 28 | Com. Pro. | Com. Ex. 1 | No Evaluation Carried Out | | | | | |
| | Ex. 1 | | | | | | | |
| Com. Ex. 29 | Com. Pro. | Com. Ex. 2 | No Evaluation Carried Out | | | | | |
| | Ex. 2 | | | | | | | |
| Com. Ex. 30 | Com. Pro. | Com. Ex. 3 | AR-2000 | MAC-O- | 7 | 21 | X | 0.5 hr |
| | Ex. 3 | | Silver | 1800W | | | | |
| Com. Ex. 31 | Com. Pro. | Com. Ex. 4 | Metallic | | 17 | 35 | ◯ | 5 hr |
| | Ex. 4 | | | | | | | |
| Com. Ex. 32 | Com. Pro. | Com. Ex. 5 | | | 15 | 29 | X | 1 hr |
| | Ex. 5 | | | | | | | |
| Com. Ex. 33 | Com. Pro. | Com. Ex. 6 | | | 20 | 37 | ◯ | 5 hr |
| | Ex. 6 | | | | | | | |
| Com. Ex. 34 | Com. Pro. | Com. Ex. 7 | | | 11 | 30 | X | 1 hr |
| | Ex. 7 | | | | | | | |
| Com. Ex. 35 | Com. Pro. | Com. Ex. 8 | | | 11 | 30 | X | 1 hr |
| | Ex. 8 | | | | | | | |

| | | | |
|---|---|---|---|
| Com. Ex. 36 | Com. Pro. | Com. Ex. 9 | No Evaluation Carried Out |
| | Ex. 9 | | |

TABLE 7

| | | | | | | | Pot Life |
|---|---|---|---|---|---|---|---|
| | | | | | | | of |
| | Intermediate | Base | Clear | Appearance | | Water | Clear |
| | Coating | Coating | Coating | LW | SW | Resistance | Coating |
| Ex. 29 | Pro. Ex. 8 | AR-2000 | Ex. 15 | 10 | 25 | ◯ | 5 hr |
| Ex. 30 | | Silver | Ex. 16 | 11 | 25 | ◯ | 5 hr |
| Ex. 31 | | Metallic | Ex. 17 | 10 | 26 | ◯ | 5 hr |
| Ex. 32 | | | Ex. 18 | 10 | 25 | ◯ | 5 hr |
| Ex. 33 | | | Ex. 19 | 11 | 27 | ◯ | 5 hr |
| Ex. 34 | | | Ex. 20 | 11 | 28 | ◯ | 5 hr |
| Ex. 35 | | | Ex. 21 | 10 | 25 | ◯ | 5 hr |

| Com. Ex. 37 | Com. Ex. 19 | No Evaluation Carried Out | | | |
|---|---|---|---|---|---|
| Com. Ex. 38 | Com. Ex. 20 | No Evaluation Carried Out | | | |
| Com. Ex. 39 | Com. Ex. 21 | 15 | 35 | X | 1 hr |
| Com. Ex. 40 | Com. Ex. 22 | 17 | 36 | Δ | 5 hr |
| Com. Ex. 41 | Com. Ex. 23 | 17 | 39 | X | 1 hr |
| Com. Ex. 42 | Com. Ex. 24 | 15 | 29 | ◯ | 5 hr |
| Com. Ex. 43 | Com. Ex. 25 | 15 | 30 | X | 1 hr |
| Com. Ex. 44 | Com. Ex. 26 | 11 | 30 | X | 1 hr |

| | | |
|---|---|---|
| Com. Ex. 45 | Com. Ex. 27 | No Evaluation Carried Out |

*Abbreviation:
Ex. stands for “Example”.
Pro. Ex. stands for “Production Example”.
Com. Ex. stands for “Comparative Example”.
Com. Pro. Ex. stands for “Comparative Production Example”.

<Appearance Evaluation of Multilayer Coating Film>

Finishing appearances of the multilayer coating films were evaluated by measuring LW (measurement wave length: 1,300 through 12,000 μm) and SW (measurement wave length: 300 through 1,200 μm), by use of Wave Scan (manufacture by BYK Gardner). A lower value indicates a better appearance of the coating film.

<Water Resistance>

The samples were immersed in warm water of 40° C. for 10 days. After that, the samples were washed for 1 hour, and appearances of the samples were observed with eyes, and evaluated based on the following criteria. The multilayer coating films evaluated as “double-circle” or “single circle” did not have any problems for practical use.

Double circles mean “No change”.

Single circles mean “A part immersed in warm water was slightly swollen but restored rapidly”.

Triangles mean “A part immersed in warm water was slightly swollen and it took time that the part restored”.

Crosses mean “A part immersed in warm water was significantly swollen and it took long time that the part restored”.

The present invention is effectively used as a two-component thermosetting resin composition and the like, which are easily dealt with, formed into a coating film having an excellent appearance, and further, have an excellent pot life.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A water dispersible resin for being contained in a base component of a two-component thermosetting resin composition,
the water dispersible resin being prepared by dispersing a solvent resin in water, which solvent resin is obtained by solution polymerization, carried out in two or more stages, of a monomer mixture containing a polyfunctional monomer, an acid group-containing monomer, and a hydroxyl group-containing monomer, the polyfunctional monomer having a plurality of vinyl groups in its single molecule,
the monomer mixture containing the polyfunctional monomer by not less than 0.1% by weight but not more than 3% by weight, and
the water dispersible resin having:
an acid value of solid content of not less than 10 mgKOH/g but not more than 45 mgKOH/g;
a hydroxyl value of solid content of not less than 50 mgKOH/g but not more than 200 mgKOH/g; and
a viscosity of not less than 50 mPa·s but not more than 10,000 mPa·s when a nonvolatile content is 45% by weight.

2. The water dispersible resin as set forth in claim 1, wherein:
the solution polymerization is carried out in two stages.

3. The water dispersible resin as set forth in claim 1, wherein:
the solution polymerization is carried out in two or more stages such that the monomer mixture is divided into monomer mixtures 1 through n so that the monomer mixtures 1 through n are separately added sequentially in this order and polymerized where n is the number of stages of the polymerization, and
a weight ratio between the monomer mixtures 1 through n-1 and the monomer mixture n is in a range of 5:5 through 9:1.

4. The water dispersible resin as set forth in claim 3, wherein:
a ratio of the polyfunctional monomer used in the monomer mixtures 1 through n-1 is not less than 80% by weight but not more than 100% by weight, with respect to an entire amount of the polyfunctional monomer.

5. The water dispersible resin as set forth in claim 3, wherein:
a ratio of the acid group-containing monomer used in the monomer mixture n is not less than 90% by weight but not more than 100% by weight, with respect to an entire amount of the acid group-containing monomer.

6. The water dispersible resin as set forth in claim 3, wherein:
a ratio of the hydroxyl group-containing monomer used in the monomer mixture n is not less than 20% by weight but not more than 65% by weight, with respect to an entire amount of the hydroxyl group-containing monomer.

7. A two-component thermosetting resin composition comprising:
a base component containing a water dispersible resin as set forth in claim 1, and a curing agent containing a polyisocyanate having water dispersibility.

8. The two-component thermosetting resin composition as set forth in claim 7, wherein:
an equivalent ratio between a hydroxy group contained in the base component and an isocyanate group contained in the curing agent is not less than 1 but not more than 2.

9. The two-component thermosetting resin composition as set forth in claim 7, wherein:
the two-component thermosetting resin composition is a composition for top coating.

10. The two-component thermosetting resin composition as set forth in claim 7, wherein:
the two-component thermosetting resin composition is a composition for base coating.

11. The two-component thermosetting resin composition as set forth in claim 7, wherein:
the two-component thermosetting resin composition is a composition for intermediate coating.

12. The two-component thermosetting resin composition as set forth in claim 7, wherein:
the two-component thermosetting resin composition is a primer surfacer.

13. The two-component thermosetting resin composition as set forth in claim 9, being for use in a method for forming a multilayer coating film,
said method including the steps of:
(1) forming an intermediate coating film by applying a composition for intermediate coating on a surface of an object to be coated;
(2) forming a base coating film and a top coating film by applying sequentially, by a wet-on-wet coating technique, a composition for base coating and a composition for top coating to the intermediate coating film that is not fully cured; and
(3) curing simultaneously, by heating, the intermediate coating film, the base coating film, and the top coating film, obtained in the steps (1) and (2).

14. A method for producing a water dispersible resin that is for being contained in a base component of a two-component thermosetting resin composition including, as a curing agent, a polyisocyanate having water dispersibility,
said method comprising the steps of:
carrying out, in two or more stages, solution polymerization of a monomer mixture so as to obtain a solvent resin, the monomer mixture containing a polyfunctional monomer having a plurality of vinyl groups in its single molecule, an acid group-containing monomer, and a hydroxyl group-containing monomer; and
dispersing the solvent resin in water,
the monomer mixture having polyfunctional monomer content by not less than 0.1% by weight but not more than 3% by weight,
the monomer mixture having an acid value of not less than 10 mgKOH/g but not more than 45 mgKOH/g, and
the monomer mixture having a hydroxyl value of not less than 50 mgKOH/g but not more than 200 mgKOH/g.
